(19) United States
(12) Patent Application Publication
(10) Pub. No.: US 2002/0138762 A1
(43) Pub. Date: Sep. 26, 2002

(54) Management of log archival and reporting for data network security systems

(76) Inventor: Donald R. Horne, Kemptville (CA)

Correspondence Address: NORTEL NETWORKS LIMITED, Intellectual Property Law Group, P.O. Box 3511, Station "C", Ottawa, ON, K1Y 4H7, CA

(21) Appl. No.: 09/996,671

(22) Filed: Nov. 30, 2001

(30) Foreign Application Priority Data
Dec. 1, 2000 (CA) 2,327,211

(51) Int. Cl. G06F 11/30; G06F 17/30

(52) U.S. Cl. 713/201; 709/223; 707/200

(57) ABSTRACT

A system and method for security management comprising log archival and reporting is provided using a novel architecture with particular application which is scalable for larger scale global data networks. The system comprises a Log Collection unit, interfacing with a Data Analysis and Log Archival unit, and a Data and System Access Unit interfacing with the Data Analysis and Log Archival Unit. The Log Collection Unit comprises a Log Collector Manager for managing log collection from a plurality log collectors interfacing with one or more security devices. The log collection unit transfers logfiles to a Storage Manager and a Data Analysis manager, connected to a Data Analysis Store, of the Data Analysis and Log Archival unit, which also comprises a Archival unit associated with the Storage unit. The system provides for separation of logfile analysis and archival of logfiles, which improves scalability of the system. The Data and System Access unit provides a user interface for the system, preferably web based.

### FIELD OF THE INVENTION

This invention relates to management of security systems for data communications networks, and in particular relates to security audit logs and management of security device log archival and reporting.

### BACKGROUND OF THE INVENTION

With increasing regularity, public and private data networks are interconnecting mission critical systems. As a result, the security of these data networks has become a growing concern. Security audit logs provide a mechanism for detecting compromise of network devices by maintaining an audit trail of user activities and events generated by the various systems that make up the network.

Audit trails provide a means to accomplish several security related objectives. These include, for example, individual accountability, reconstruction of past events, intrusion detection and problem analysis.

Basic security log reporting is provided by several companies products, e.g. WebTrends™ and Telemate™ which are two of the most popular firewall log analysis products currently on the market.

Nevertheless, these applications are currently limited in their ability to scale to large enterprises and global operations. There are currently no offerings available which would be suitable for large carrier class customers, such as ASPs Application Service Providers and Internet Service Providers ISPs.

These systems are increasingly complex, and link heterogeneous security devices, e.g. firewalls, extranet switches and drop boxes, distributed globally.

The lack of scalablity of current systems arises from several factors.

Current systems archive logfiles to a general database table where logfile analysis is then done by performing select queries using the fields defined in the database table. This is not a scalable solution today, and will become even less so as the volumes of data increase.

One of the main issues in scaling current systems is that they involve a direct connection of all security devices to the main logging/archival server, which is not compatible with globally distributed systems.

Security is an issue where, as in current systems, all security devices need to contact the log archival server, and it is therefore necessary to firewall the one-to-many connection with these units.

Thus larger customers need a system which overcomes these issues and provides features including automated summary and performance metrics, custom log analysis capabilities, and an ability to key into unusual activity and possible abuse, and trigger alarms. Other desirable features include trend analysis. Different levels of authorized access are required and special access capabilities for security investigations.

With respect to archival, typically security logs are treated as confidential corporate data, and may require that security logs are archived anywhere from a few months to a number of years.

### SUMMARY OF THE INVENTION

Thus the present invention seeks to circumvent or overcome the above mentioned problems by providing a novel architecture for security management systems comprising log archival and reporting for data networks, with particular application for larger scale global data networks.

Thus, according to an aspect of the invention, there is provided a security device log and reporting system wherein archival of log files is separated from analysis of logfiles.

Separation of log file analysis and archival provides for improved scalability of the system

According to another aspect of the invention there is provided security device log and reporting system comprising a Log Manager, the Log Manager having a distributed interface for receiving logfiles from a plurality of security devices, and is the interface to a Data Analysis and Archival unit of the system.

Beneficially the Log Manager comprises an intermediary caching system for log files received from the plurality of security devices.

Advantageously, the system comprises a Data Analysis and Archival Unit, a Log Collection Unit comprising a Log Manager, and Data and System Access Unit, wherein the Data Analysis and Archival Unit interfaces with only a Log Manager and a Data and System Access Unit, whereby interfaces are easily protected via a firewall and intrusion detection system.

Another aspect of the invention provides a security device log and reporting system for a data network, comprising:

a Log Collection unit, for collecting log files from security devices,

a Data Analysis and Log Archival unit for analysis and archival of log files,

and a Data and System Access Unit providing a user interface with the Data Analysis and Log Archival Unit.

Beneficially, the Log Collection unit comprises a Log Manager for managing log collection from a plurality of security devices.

Alternatively, the Log Collection unit comprises a plurality of log collectors and a Log Collection Manager for managing log collection from a plurality of log collectors.

Another aspect of the invention provides a data network security management system for security device log archival and reporting comprising:

a Log Collection Unit comprising a plurality of log collectors, each for collecting log files from a plurality of security device nodes and a log manager for collecting log files from a plurality of log collectors;

a Data Analysis and Log Archival unit for archival and automated analysis of log files received from the log manager; and

a Data and System Access unit providing a user interface to the Data Analysis and Log Archival Unit.

The Log Collection Unit provides output to a storage manager and a Data Analysis manager, connected to a Data Analysis Store, of the Data Analysis and Log Archival unit, which also comprises an Archival unit associated with the Storage Manager.

Preferably, the user interface is a web based user interface, and the Data and System Access unit wherein the user interface provides for log analysis summaries, trend analysis, controlled operational access and system configuration.

For security, the Access unit comprises an authenticated, authorized, secured web based system.

The system is designed so that the Log Collection Unit may receive logfiles from security devices comprising one or more device types including, for example:

Firewalls, (Raptor 4, Raptor 6, CES CheckPoint Firewall-1),

Remote access services (RAS),

CES (Contivity Extranet Switch),

SPAM (Mailshield),

FTP Drop Box, and

Anti-Virus (Antigen)

Another aspect of the invention provides a Log Manager for a data network security management system, wherein the Log Manager (LM) interfaces with a Data Analysis Manager (DAM) and a Storage Manager (SM) and the LM comprises:

means for collecting logfiles from security devices,

means for pushing cached SD logfiles to a Storage manager for archival, and

means for providing log archival status updates to a Data Analysis Manager (DAM).

In another system according to the invention, the Log Collector Manager (LCM) interfaces with a Data Analysis Manager (DAM) and a Storage Manager (SM) and the LCM comprises:

means for receiving logfiles from the plurality of log collectors,

means for obtaining a logging system configuration from the DAM,

means for propagating the configuration to individual LC associated with Security devices,

means for providing notification to the LC to begin transfer of SD log files,

means for pushing cached SD log files to the Storage manager for archival, and

means for providing log archival status updates to the DAM.

According to another aspect of the invention the system includes a Data Analysis and Log Archival unit which comprises a Storage Manager (SM) and a Data Analysis Manager (DAM) and the SM comprises:

means to receive security device logs from the Log Collector Manager,

means for system archival,

means for management of online and offline log archivals and transition of logs form online to offline status,

means to provide the Data Analysis Manager (DAM) with access to SD logs on request, and

means to provide the DAM with access to the SM log Archival tables on request.

Beneficially, the system is scalable in a global environment for reasons set out below, and provides for a web interface into the system.

Yet another aspect of the invention provides a method of managing security device log archival and reporting for a data network security, comprising:

collecting log files from a security device node at a log collector,

collecting log files from a plurality of log collectors at a log collection manager,

transferring log files from the log collection manager to a data analysis and log archival unit for archival and analysis, logfile analysis being separated from log file archival.

The method may include providing user access to the Data analysis and log archival unit via a data and system access unit.

Another aspect of the invention provides a Storage Manager for a security device log archival and reporting system comprising:

means for receiving security device logs from the log collector manager for system archival,

means for management of online and offline log archival and transition of logs from online to offline status,

means for providing the DAM with access to security device logs on request, and

means for providing the DAM with access to the SM log archival tables on request.

The storage manager beneficially comprises means for differentiating types of log files.

The following factors contribute to scalability that known logging systems do not provide.

The separation of logfile analysis from logfile archival. Archival and analysis of logfiles are separated into two separate databases. The archival database (i.e. the Storage Manager), manages where logfiles are physically located on media, as well as the attributes of the logfile. The analysis of the logfile is done independently of a database with only the results of the analysis stored in the analysis database (i.e. the Data Analysis Store). This does not preclude subsequent analyses of a logfile as the logfile is still available. This approach differs from current systems which archive logfiles to a general database table where logfile analysis is then done by performing select queries using the fields defined in the database table.

The architecture of the system provides that the Log Manager is designed to be the distributed interface for devices to input their logs. The Log Manager then becomes the interface to the data archival and log analysis servers of the system. The Log Manager also acts as an intermediary caching system allowing end devices to offload their logs in a more efficient manner. As Log Managers can be globally distributed yet still be centrally managed this increases the scalability of the system.

The architecture of the system is such that the log archival and analysis components are easily secured via a firewall and intrusion detection system. This is achievable by the distributed components of the system. The only physical machines that need to interface with the archival and analysis components of the system are the Log Managers and the Web Application Server (i.e. machine which hosts the web interface). Instead of having to firewall a one-to-many relationship found in current systems where all devices need to contact the log archival server, one only has to firewall a one-to-few relationship. The effect is that a larger, secure archival system is achievable whereas to achieve the same security with other systems it would mean managing multiple contexts of the system. This is important in that the architecture provides for for the analysis and archival of confidential data.

The ability to differentiate types of logfiles as per legal and corporate security requirements is not currently available in any other system.

In a system currently in operation the system handles the archival and analysis of 92 globally dispersed security devices on a daily basis. The device archival and analysis is provided for firewalls (e.g. Raptor 4, Raptor6, CES Checkpoint Firewall-1) extranet switches and Remote access services, SPAM (Mailshield) and FTP Dropboxes and Anti-Virus. Soon to be in production will be the archival and analysis of Intrusion Detection alarms (Internet Security System's network intrusion detection), and personal firewalls (e.g. CyberArmor).

The system preferably provides authorization support for views based on device type, database driven filter configurations and analysis store. Reports on general metrics, monthly metrics and user metrics may be generated.

Advantageously, the system uses a CORBA (Common Object Request Broker Architecture) driven system backend for communication between the system components.

Thus the system provides for many aspects of management of log files according to corporate and legal requirements, automated archival and automated or custom analysis, and logfile exception reporting, and for example archival and analysis of ISS vulnerability assessments.

Beneficially, such a system can be implemented to be multi-vendor interoperable. Operational analysis can be simplified if a standard format for security device logs is adopted.

The systems and methods described herein improves the ability of Security Operations to manage an increasingly complex, heterogeneous environment of Security Devices (e.g. firewalls, extranet switches, dropboxes) through support automation, thereby increasing the effectiveness of existing operations personnel. A level of data security is added to the infrastructure for the management of security devices protecting corporate resources and the audit capabilities of the security infrastructure are increased. The system improves the ability to generate security device metrics while providing secure web access to those metrics. The resulting Security Devices Log and Reporting system provides a foundation block for an enterprise security environment called Intrusion Monitoring and Management of Unified NEtworks Systems (IMMUNEsystem).

Thus, the design of the system is distinguished by its architecture and functionality, in providing a system which is readily scalable for large network applications comprising globally dispersed security devices.

### BRIEF DESCRIPTION OF THE DRAWINGS

The invention will now be described in greater detail with reference to the attached drawings wherein:

FIG. 1 shows a schematic representation the IMMUNE security environment comprising a security devices log and reporting system according to an embodiment of the invention;

FIG. 2 shows a logical view of a system according to a second embodiment of the invention

FIGS. 3 to 14 respectively show examples of screen views presented by the Web interface of the Web Application Server, which provides an overview of categories of screen views that may be presented to an authenticated user.

### DETAILED DESCRIPTION OF THE EMBODIMENTS

[note: a glossary of acronyms presented at end of this section, preceding the Claims section]

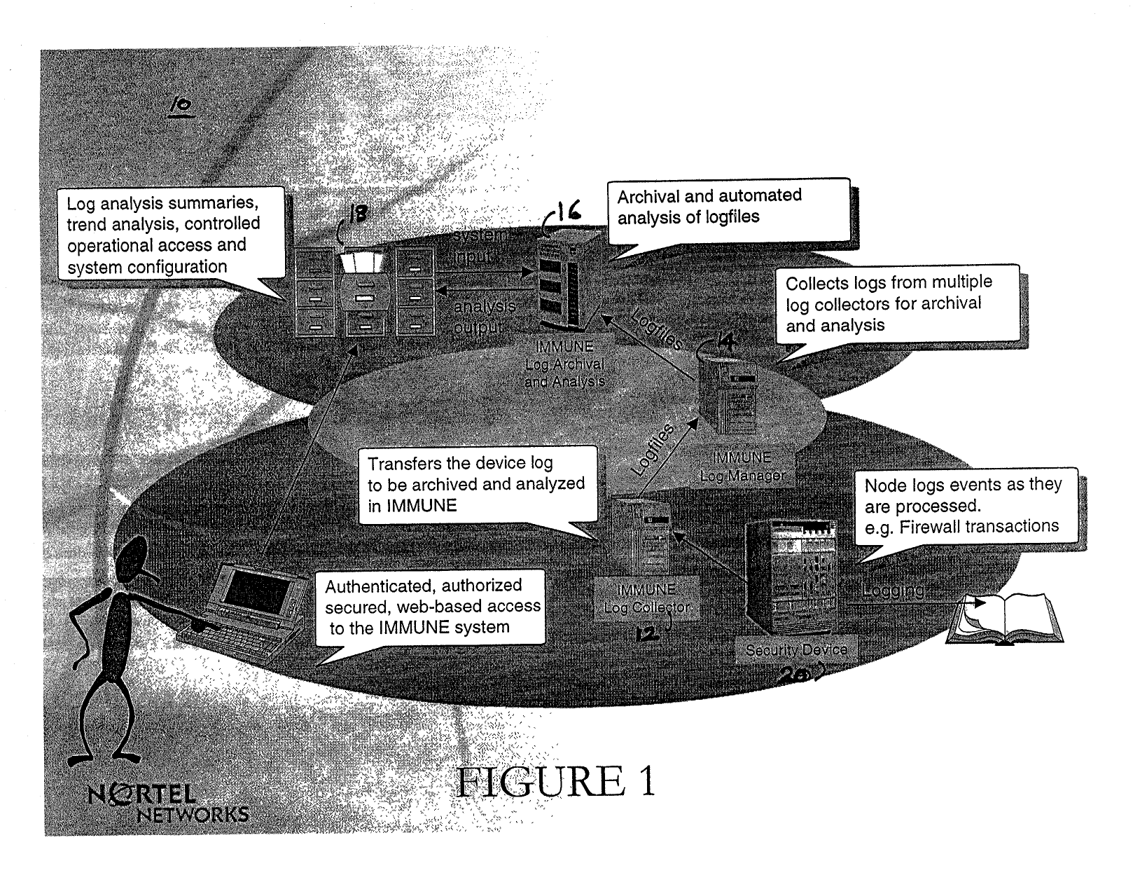

The IMMUNE security environment according to an embodiment of the invention is represented schematically in FIG. 1.

The system 10 for security devices log and reporting comprises the Log Collector (LC) 12, Log Manager (LM) 14, and Data Analysis and Log Archival Unit 16, and Data and System Access Unit 18. Log Collector (LC) 12 interfaces to a security device (SD) 20 which=logs events as they are processed, e.g. Firewall transactions. The Log Collector (LC) 12 transfers the security device log to be archived and analysed in IMMUNE to the Log Manager (LM) 14. The Log Manager (LM) 14 may collect logs from multiple Log og collectors (not shown) for archival and analysis, and then transfers the logfiles to the Data Analysis and Log Archival Unit 16, which performs archival and automated analysis of the log files. The Data and System Access Unit 18 provides a authenticated, authorised, secured, web based access to the IMMUNE system, and provides log analysis summaries, trend analysis, controlled operations access and system configuration.

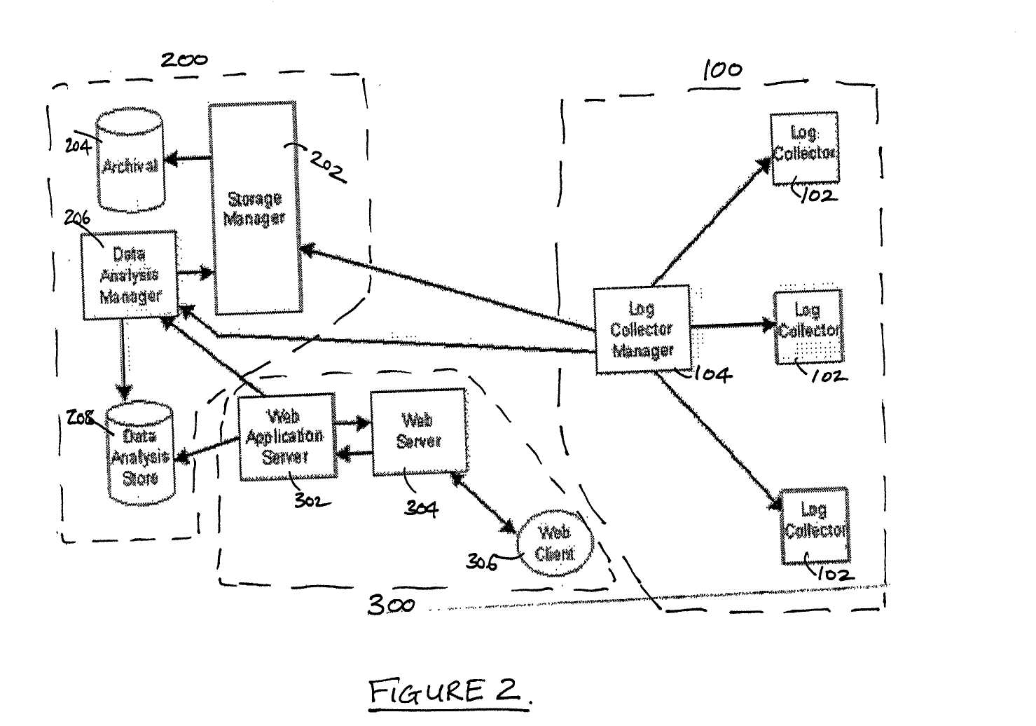

The Security Devices Log and Reporting System (SDLRS) according to a second embodiment shown in FIG. 2 described below is targeted at improving the management and access to the logging of a plurality of heterogeneous Security Devices (SD)for: operational and business value metrics; keying into possible abuse; legal obligations; security investigations. The SDLRS will manage logs on a configurable basis, but the focus is on performing log analysis and log archival for SD on a daily or other regular basis.

The system according to the embodiment shown in FIG. 2 was designed to use a known UNIX based system, for example Solaris or HP-UX for the underlying system components such that the hardening of the Operating Systems adds to the overall level of system security.

Available third-party components capable of providing the intended function were used during the design phase when ever possible. The use of Internet standards-based security are utilized whenever possible.

Component Layout and Unit Description

The logical view of the components making up the SDLRS 100 is contained in FIG. 2, which represents the system schematically, with no assumption made as to the ratio of components to computers. The server objects (e.g. Storage Manager, Log Manager) can run on the same computer or on different computers, which adds to the scalability of the solution.

There are three distinct parts of the SDLRS 100. These three parts indicated in dotted outline in FIG. 2 are:

Log Collection Unit 100

Data Analysis and Log Archival Unit 200

Data and System Access Unit 300

The Log Collection Unit 100 comprises the Log Collectors 102, which are those system modules that operate in conjunction with the logging mechanism provided by Security Devices SD which an enterprise uses to manage data security within the enterprise network. The Log Collectors LC 102 interface directly with a Security device logging mechanism. The Log Collector Manager LCM 104, which provides for coordinating the collection of SD logs from a plurality of Log Collectors 102. The LCM 104 transfers the logs to the Log Archival Unit 200 which comprises the Storage

Manager 202 and the LCM provides also for notifying the Data Analysis Manager 206 of a list of newly archived SD logs.

Advantageously, the Log Collector Manager LCM acts as a SD log caching server, and the existence of the Log Collector Manager also allows for the ease of operationally securing the Data Analysis and Log Archival Unit 200 from unnecessary access by other nodes on the network.

The Data Analysis and Log Archival Unit comprises the Storage Manager 202 and Data Analysis Manager 206. Storage Manager 202 which is responsible for giving the Data Analysis Manager 206 the identification, archival information, eg and location of newly arrived logs, and for managing the archival of logs online and offline on the Archival Unit 204. Also part of the Data Analysis and Log Archival Unit is the Data Analysis Manager 206 and Data Analysis Store 208. Data Analysis Manager 206 provides each system component with configuration details, analyses logs using the appropriate data filter, and sends the extracted metrics to the Data Analysis Store 208. The Data Analysis Store 208 is for storing system configurations, summary and operational metrics, data filter configurations, and job statuses of data analyses.

The Data and System Access Unit 300 comprises the Web Application Server 302, Web server 304 and Web client 306. The Web Application Server 302 includes the applications that allow the user to interface with the SDLRS for functions such as authentication/access, data filters, and system setting configurations, and for the retrieval of summary metrics from the Data Analysis Store 208. As well, the Web Application Server consists of applications which allow the user to interface directly with the Data Analysis Manager 206 for applications such as custom metrics analysis, and raw data log manipulation. The Web Server 304 is responsible for providing the SDLRS screen views to the Web Client 306 for presentation.

In a system currently in operation the system handles the archival and analysis of 92 globally dispersed security devices on a daily basis. The device archival and analysis is provided for firewalls (Raptor 4, Raptor6, CES Checkpoint Firewall-1) extranet switches and Remote access services, SPAM (Mailshield), FTP Dropboxes and Anti-Virus. Soon to be in production will be the archival and analysis of Intrusion Detection alarms (Internet Security System's network intrusion detection), and personal firewalls (CyberArmor).

Component Detailed Description

Log Collection Unit:

Log Collector (LC)

A LC may be identified for each SD, or a group of SDs depending on the SD technology. In either case, the LC is responsible for the following during the log retrieval process: accessing the SD log(s), securely (i.e., authentication, privacy) transferring the SD log(s) to the Log Collection Manager (LCM); cleanup of transferred log(s) on the SD. As SD logging occurs as a function of the SD software, the LC will be “tuned” to work for each type of SD. For example, retrieval of SD log(s) will be on a 24 hour basis by default, but the LC will accept input from the LCM to increase the frequency of log retrieval in hourly intervals. Cleanup of SD logs will be, typicially, on a 7 day basis by default, but the LC will accept input from the LCM to increase the frequency of log cleanup in daily intervals.

Log Collector Manager (LCM)

The number of LCMs in the system may be one or more with the responsibility of an LCM being that of co-ordination and retrieval of a number of different SD operational and system performance logs. The LCM contacts the Data Analysis Manager (DAM) on a, e.g., 24 hour basis to acquire its assigned SD identification list, and the log retrieval and cleanup configuration settings for the system. During the log retrieval process, the LCM performs the following: initiates the connection to the LC; provides system configuration updates for log retrieval and log cleanup frequencies to the LC; securely pulls the SD log(s). Logs that have been securely pulled, are then securely pushed to the Storage Manager (SM) for archival with the LCM providing for each log transfer the device type, date, and SD name to the SM. Upon the transfer of an SD log(s) to the SM, the DAM is notified of the job status, and in the case of errors the error code.

Upon completion of all log transfers, the LCM notifies the DAM with an “end of transactions” notification.

Data Analysis and Log Archival Unit:

Storage Manager (SM)

The SM is responsible for SD log archival in the correct location, maintaining an index of log archivals according to SD and export control configuration settings, and backups of the log archiving system. As part of the log transfer process, the LCM begins a secure log transfer to the SM with the date, device type, and SD name for the log being transferred. From this information, the SM then selects the appropriate on-line archival directory where the log will be written. Upon successful completion of the log transfer, the SM then updates its index of log archivals.

To manage the transition of logs from on-line to off-line archival, the SM receives from the DAM the log retention configurations for the system on a daily basis. In an operational system, for example, by default the log archival configurations are set at the following: perimeter devices—3 months on-line and 15 months off-line; export controlled devices—3 months on-line and 57 months off-line (where a total of 60 month, or 5 year, archival is required); drop-box devices—3 months on-line and 15 months off-line; devices classified as “other” (e.g. SPAM logs)—3 months on-line. Other default values may be set as appropriate. The SM then manages the transition of on-line log archival to off-line archival by performing disk cycling, off-line archival backups, and the updating of the log archival index.

Upon receiving log location requests from the DAM, the SM references the archival index for the location of the log. If the log is on-line, then the file path is given to the DAM. If the log is found to be off-line, then the DAM is informed that the log is off-line. Archival information for specific SD logs or for the complete on-line or off-line indices can be provided to the DAM on request.

Data Analysis Manager (DAM)

The DAM is responsible for providing the configuration details to the other system components, ensuring that all SD logs are archived, performing data analysis on SD logs, providing summary statistics to the Data Analysis Store (DAS), and querying the SM for log archival information upon request. To perform log analysis, the DAM runs in two concurrent capable modes: automated analysis; custom analysis.

In the automated analysis mode, the DAM dynamically determines via DNS lookups the list of SDs from which logs are to be retrieved. SDs having been assigned hostnames/aliases that indicate their security function and geographical location are then categorized into SD lists associated with the LCM(s) in the system. The system configuration data for log retrieval interval, log cleanup interval, log storage interval, and filter configurations are retrieved from the DAS.

When an LCM contacts the DAM, the LCM is provided with the log retrieval, and log cleanup configurations, as well as the SD list for which that LCM is responsible. The SM is notified of the system log archival configuration. The DAM then retrieves the filter configurations for each of the SD categories. As the LCM(s) notify the DAM of the successful transfer of SD logs, the DAM then contacts the SM for the location of the SD log such that the appropriate data filter can be applied to the log. Once the data analysis is complete, the summary metrics for the SD are saved to the DAS. The DAM is responsible for managing the list of SD log retrievals, and the recording of errors and job statuses to the DAS.

In the custom analysis mode, the Web Application Server (WAS) contacts the DAM and requests log archival information, or the WAS provides the date, time, SD category, and name for those logs which data analysis is requested. The DAM contacts the SM for log archival information, or for the location of the log(s). In the scenario where a specific log(s) are requested and found to be on-line, then the appropriate data filter configuration is retrieved from the DAS,and presented to the WAS for acceptance. The WAS then provides the DAM with the desired data filter configuration which the DAM then applies to the SDlog(s). Summary metrics from the custom data analysis of the log(s) are then provided to the WAS.

Data Analysis Store (DAS)

The DAS is a database to which configurations, data metrics, job statuses, and authentication and access levels are stored. Configuration data exists for system archival, log retrieval, log cleanup, and the various SD category data filters. Data metrics derived out of the automated analyses are stored for each SD. Job statuses and errors for all SDs are stored for each period (default is on a per day basis) of data analysis. Access and profile information for viewing system logs and configurations are stored as well.

Data and System Access Unit:

Web Application Server (WAS)

The WAS consists of all the applications which provide the system and data interfaces to the user. The system views consist of the following: system configuration parameters; SD category filter configurations; access and view profile settings for definable user categories; SD and SD category data metrics views and reports; SD raw log view; alarms and job statuses.

The system configuration application presents a view for defining the system parameters: log retrieval frequency; log cleanup frequency; log archival periods; access list of certificates/ids allowed access to the system; profiles which determine what views a user has access to when authenticated. The profiles are configurable for a variable number of SD categories, but by default the profiles are: SECOPS (Security Operations)—access to all functionality; SPAM (i.e. “junk e-mail”)—access to SPAM log data; RAS—access to Contivity Extranet switches maintained by RAS; SECINV (Security investigations)—access to specifiable SD logs for security investigations.

The SD data filter application presents a view from which each SD category regular expressions can be defined for automated data analyses and storage.

The SD data metrics applications can be either for general case metrics or custom requested metrics. In both cases, a view for each SD category is presented from which the user can select the data query settings to be retrieved. The application then presents the user with the data either retrieved from the DAS (general case metrics) or from the DAM (custom requested metrics).

The alarms and statuses application presents a view which is updated with the error status and job statuses of the retrieval of SD logs. The view is dynamic in that job statuses and errors are retrieved from the DAS on an hourly basis. Errors are highlighted until they have been acknowledged by an administrator. Errors and job statuses for previous dates are retrievable from the DAS.

Web Server (WS)

The WS is the user's access point into the SDLRS via the WAS. The WS authenticates the user, and sets up the SSL connection between the WS and the user's web interface.

Web Client (WC)

The WC is a web browser capable of interfacing with the WS, and hence the SDLRS.

Components Inputs and Outputs

This section provides further details of the component inputs and outputs used in the system according to the embodiment.

[image]

[image]

[image]

[image]

[image]

[image]

[image]

[image]

[image]

[image]

[image]

[image]

[image]

[image]

[image]

[image]

[image]

[image]

[image]

[image]

Web Application Server (WAS)

Was Screens:

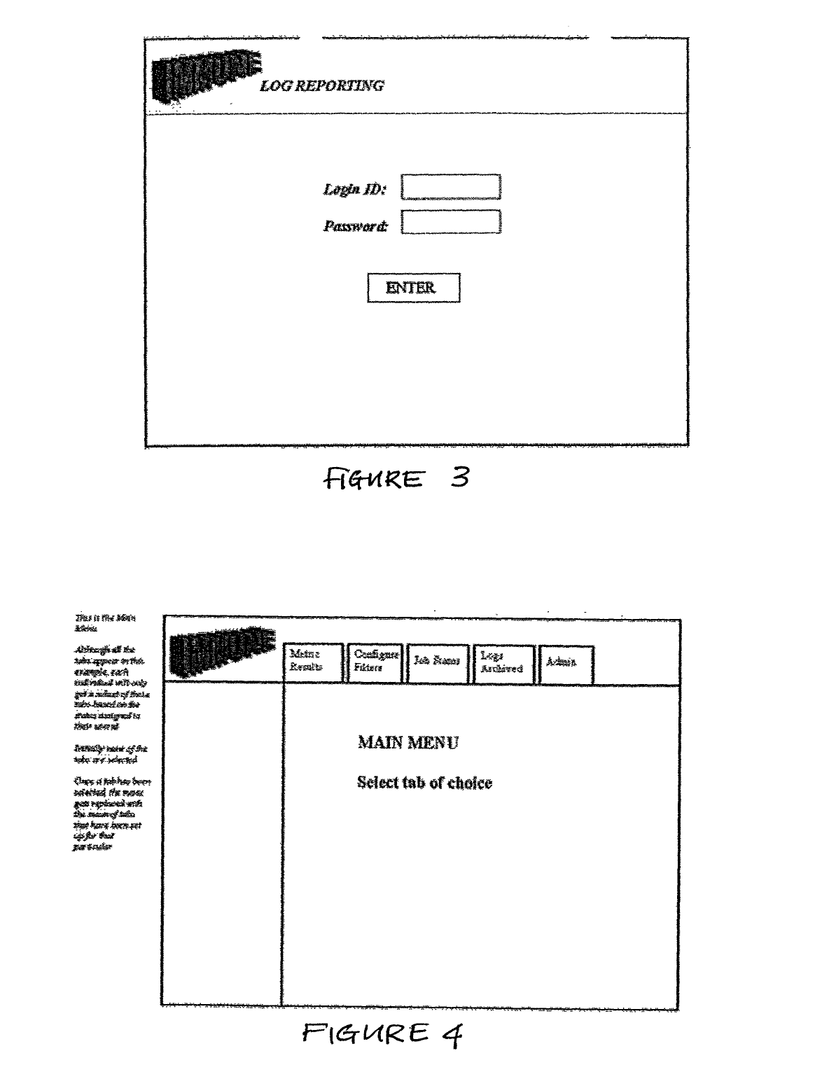

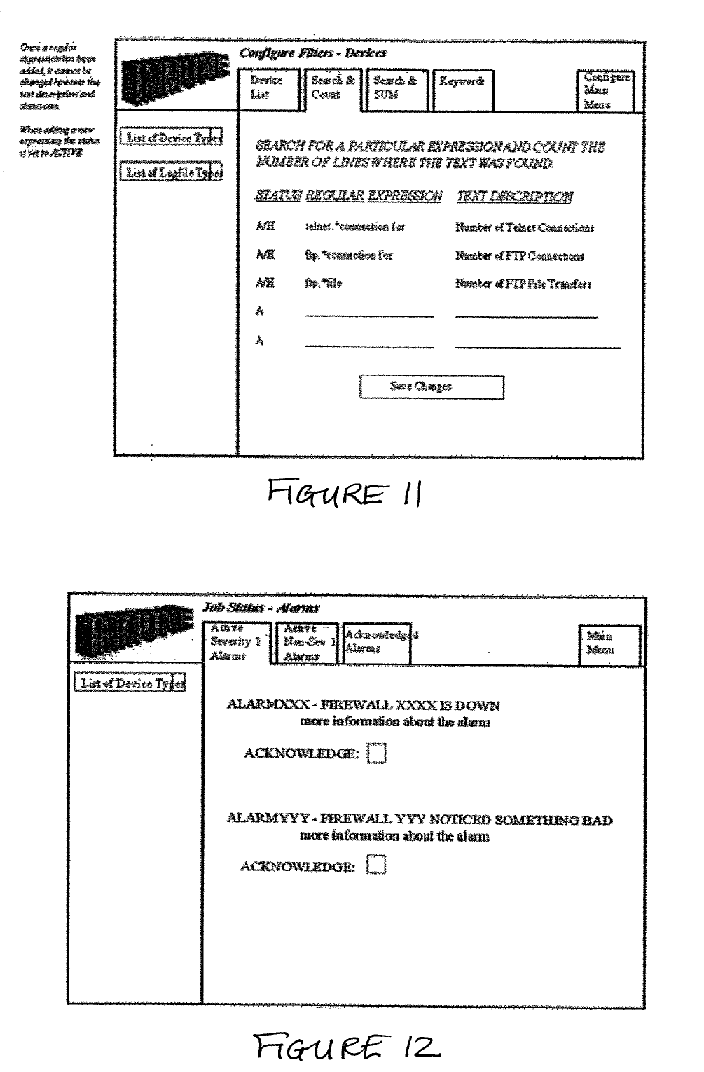

The WAS provides a graphical user interface and FIGS. 3 to 14 show some typical screen views which may be selected and which are intended to give a summary of the categories of screen views that would be presented to an authenticated user. This summary is not a complete representation of all SDLRS screen views and is shown by way of example.

The screen views which a user may select are based upon the user authenticating themselves to the SDLRS, and the access rights that the SDLRS grants to the user upon that authentication. Depending on the authenticated user's access rights, the appropriate functionality tabs at the top of each screen view will be displayed for selection.

FIG. 3 represents a Splash Screen with Authentication: After login and authentication by e.g. an authenticated Security Operations user, the user is presented with the main menu as shown in FIG. 4, providing options tabs (depending on user access rights) to select Metric Results, Configure Filters, Job Status, Logs Archived and Admin functions. Selection of the metric results screen as shown in FIG. 5 provides options to select results for e.g. firewalls, contitivity switches, FTP drop boxes, SPAM, Corporate security, or return to the main menu.

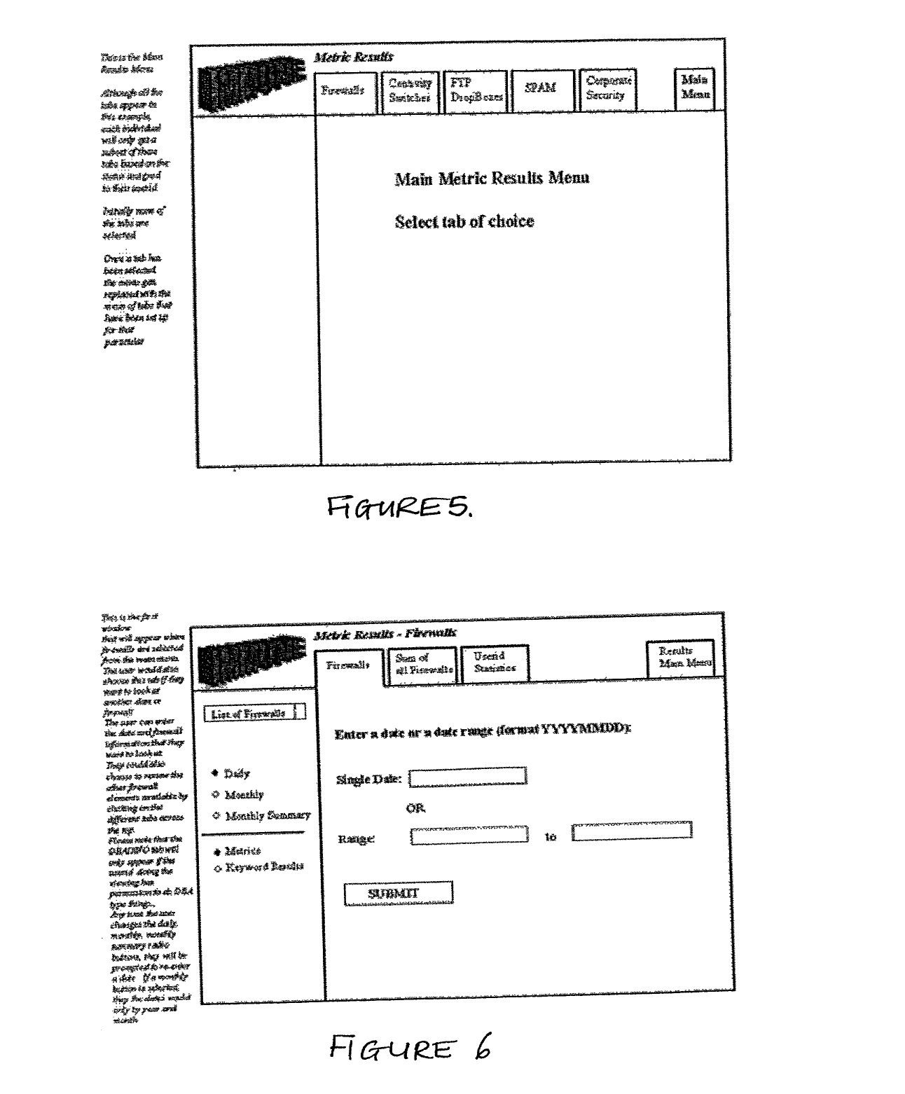

The screen shown in FIG. 6 represents a security devices metrics menu for firewalls. and the subsequent screen in FIG. 7 shows the daily metrics screen for firewalls example.

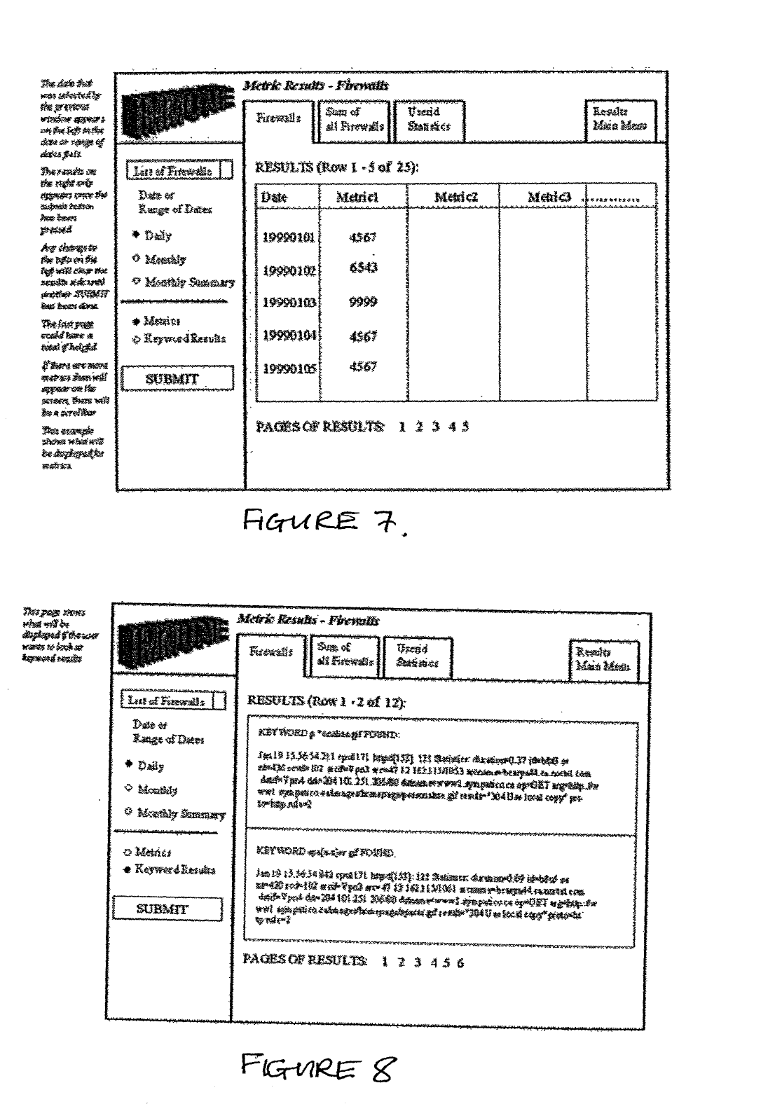

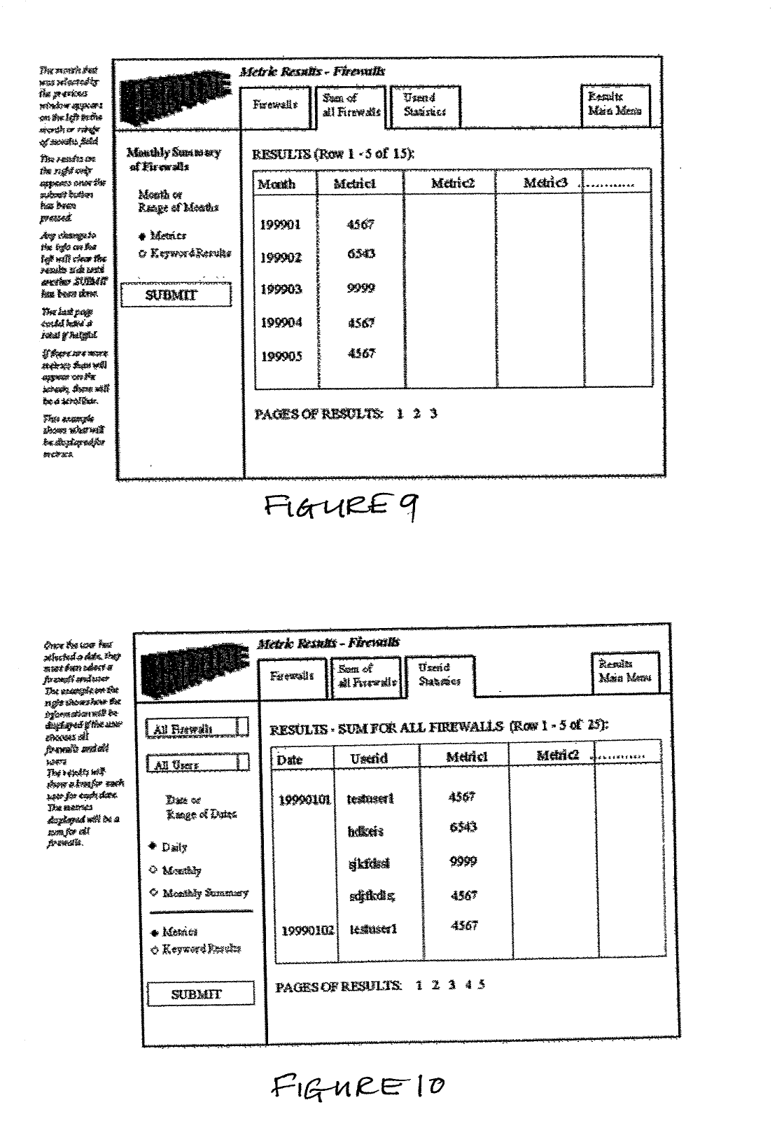

A daily keywords results screen is shown in FIG. 8 and monthly metrics screen in FIG. 9.

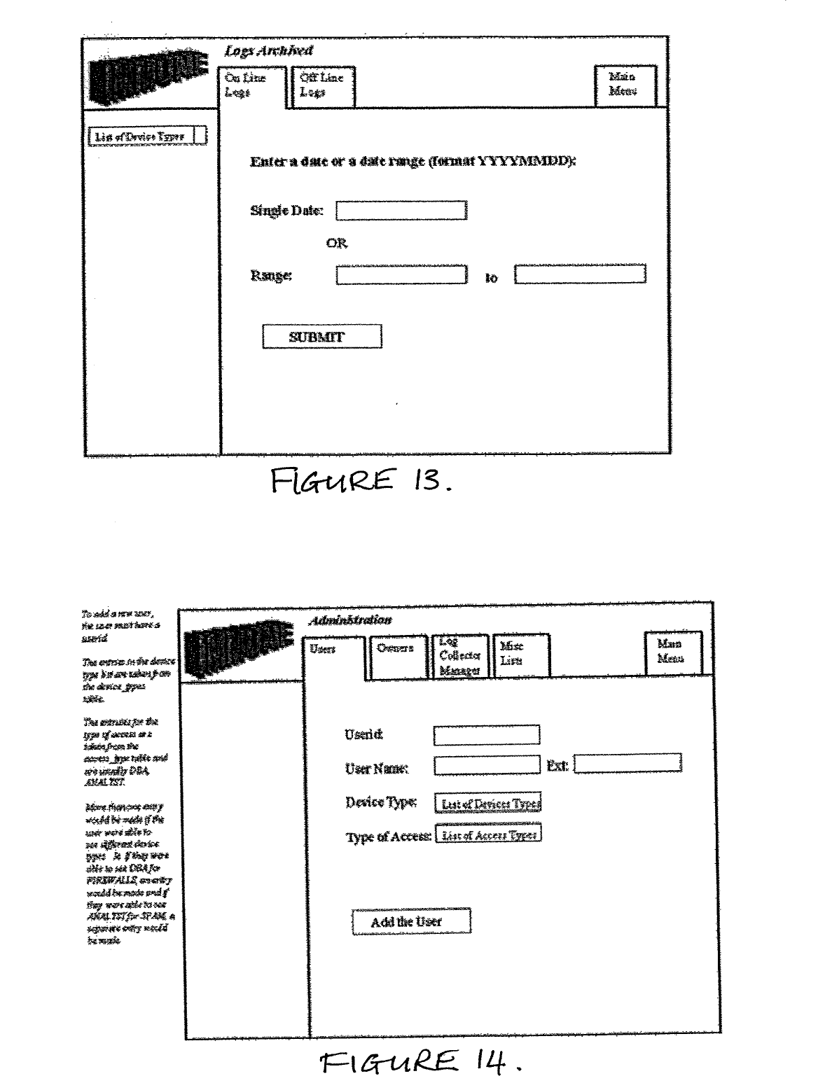

User statistics metrics screen, configure filter screen, and systems job status screen are shown in FIGS. 10, 11 and 12 respectively. The system logs archived screen, and system administration screen are shown in FIGS. 12 and 13 respectively.

WAS DATA:
Input from WS:

Authentication_Request /* for logging purposes */

Userid
IP Address

Interactions with the DAS (Input/Output):

System_Configuration

Archival_Duration={type1, type2, type3 . . . }

type‘n’={online=[number_months],

offline=[number_months]}

Retrieval_Interval={default=24 hrs | hourly

interval=1 - 24 hrs}

Cleanup_Interval={ default=7 days | weekly

interval=1 - 7days)

SDtypes={type1, type2, type3 . . . }

type‘n’={code, description}

Devicelist={device1, device2, device3 . . . } /*

Informational only as configured dynamically by the DAM
*/

Filters={filtertype1, filtertype2,

filtertype3 . . . }

filtertype‘n’={key1, key2, key3 . . . }

Alarms={alarmtype1, alarmtype2, alarmtype3 . . . }

alarmtype‘n’={key1, key2, key3 . . . }

LCMlist={lcm1, lcm2, lcm3 . . . }

lcm‘n’={FQHN, IPaddr, responsibility}

Auth_Access_List

CN_List={user1, user2, user3 . . . }

user‘n’={access_level}

Access_List={access_level1, access_level2,

access_level3 . . . }

Session_Status

Date
Sessions={session1, session2, session3 . . . }

session‘n’={status, error[1,2,3 . . . ],

alarm[1,2,3 . . . ]}

error‘n’={errorcode, description}
alarm‘n’={description}

Metrics_Reply

Device_Name
Metric1 to Metric30

Input from DAM:

Full_Text_Reply

Logfile_Text_Buffer /* for read-only access */

Custom_Metrics_Reply

Metrics_Table

Status
Errors
Alarms
Search_Results

Online_Table_Reply /* summary of logs archived

online */

Offline_Table_Reply /* summary of logs archived

offline */
Output to DAM:

Log_Location_Request /* for custom analysis */

SD_Type
SD_Name {FQHN, IP address}
Date_Range={Date | From_To}
Online={ONLINE | OFFLINE}
Offline_File_Location_List={filepath1,

filepath2, filepath3 . . . }/* restored filepath known */

FULL_TEXT={ON | OFF}

Custom_Metrics_Request

Filter_Type={customized filter keys}
SD_Type
SD_Name {FQHN}
Date_Range={Date | From_To}

Online_Table_Request
Offline_Table_Request

Output to WS:

Data fills for presentation

Web Server (WS)

Authenticates and establishes secure connection
Presentation of system to end user

Detailed Design Information for Embodiment Comprising a Log Manager (LM)

In the embodiment described above, the Log Collection Unit comprises distinct Log Collector Manager (LCM) and Log Collector (LC) components, which are described in further detail in the LCM Design section and LC Design section following.

In the embodiment shown schematically in FIG. 1, the log collection unit comprises a Log Manager (LM), this component of the Security Devices Log Reporting System (SDLRS), which is responsible for the collecting of Security Device (SD) operational logs, and the transferring of those logs to the Storage Manager (SM) for archival. In fulfilling this role, the LM also has a corresponding interaction with the Data Analysis Manager (DAM) component of the SDLRS.

The intent of this section is to provide the architecture and design of the LM and not the implementation specifics of the LM. For the ease of understanding the LM system, configuration files and tables detailed in the design, as well as example content and records are provided to highlight key fields and information that are required by the LM. The actual implementation of the files and table content may vary.

The log manager functions to:

1 provide a collection point for Security Devices (SD) to transfer their logfiles for archival.

2 Push the cached SD logfiles to the Storage Manager (SM) for archival.

3 provide Log archival status updates to the DAM.

CORBA Integration

The Log Manager (LM) acts as a CORBA client. The CORBA server interfaces with which the LM interacts during service requests are defined in the CORBA integration document, and are referred to whenever possible. They will appear as the actual interface method name preceeded by the server entity. For example, the notification represented by the LM sending the DAM a Log Archival Complete notification is DAM-LogArchDone.

System Variables

For UNIX-based LM implementations the system variables are analogous to the UNIX shell environment variables (e.g. setenv in the csh) and can therefore be used for that purpose (e.g. setenv LMDIR <DirLoc>, for the csh)

CACHEDIR :=DirLoc

The CACHEDIR variable defines the location of the logfile cache directory for the Security Device(s) (SD). The directory contains the logfiles of SD to be transferred to the Storage Manager (SM). This variable symbol is also used as a production in syntax definitions in this document.

LMDIR :=DirLoc

The LMDIR variable defines the location of the LM run-time directory, which contains the configuration files, Security Device File (SDF), Log Transfer List (LTL), and Log Exception List (LEL) for the LM. This variable symbol is also used as a production in syntax definitions in this document.

CheckInterval

The CheckInterval variable defines the number of minutes between each check by the LM for new SD logfiles.

CleanupInterval

The CleanupInterval variable defines the number of days archived SD logfiles are kept by the LM. By default the number of days equals 3.

RetrievalInterval

The RetrievalInterval variable defines the number of hours an archived SD logfile will span. By default the number of hours equals 24 (i.e. 1 retrieval per day).

Configuration Repository

The LM configuration repository at version 1.0 will be a configuration file. It is located on the LM host and uses the following syntax:

LMConfigRep LMDIR := “/” “LM.ini”

In future versions of SDLRS, the LM configuration repository may also be available via a database table. If the LM configuration repository is a database table, then it will use the following syntax:

LMConfigRep := “LMConfig” The LM validates that the $CACHEDIR directory exists.

1) The LM validates that the Security Device File, Log Transfer List, and the Log Exception List exists.

2) The LM checks the pending activity file to see if it has any pending actions to execute or restart.

Log Collection Management

The LM is responsible for transferring Security Device (SD) logfiles to the Storage Manager (SM) for archival. To perform this role within SDLRS, the LM must manage the following aspects of the archival process:

act as a temporary cache for logfiles in-transit for archival on the SM.

transfer newly arrived SD logfiles to the SM for archival.

notify the Data Analysis Manager (DAM) of SD logfiles that have been archived.

maintain an exception list of SD that have not submitted logfiles for archival.

Log Transfer Management

The LM manages the transfer of logfiles to the SM using a Security Device File (SDF) and a Log Transfer List (LTL).

Security Device File

The Security Device File (SDF) is a manually edited configuration file in $LMDIR, and it contains information relevant to the archiving of SD logfiles, as well as in the data analysis of those logfiles. Each line in the file contains the following keys in order delimited by “white space”:

| | |
|---|---|
| • SD_Name | // the FQHN, e.g. |
| bcarh001.ca.nortel.com | |
| • SD_Alias | // e.g. fw-l-a-cc |
| • SD_Type | // e.g. FW, SPM, etc. |
| • SD_SubType | // e.g. EAGLE, RAPTOR4, etc. |

An example line is provided below:

bcarh001.ca.nortel.com fw-1-a-cc FW EAGLE

Log Transfer List

A Log Transfer List (LTL) is used to keep state of which SD logfiles require transferring to the Storage Manager for archival. Each entry in the LTL is a record consisting of the following fields in order, and delimited in this example by two asterisks:

| | |
|---|---|
| SD_Name | |
| SD_Alias | |
| SD_Type | |
| SD_Subtype | |
| Date | |
| Interval_Stamp | |
| Retrieval_Interval | |
| Log_Size | // expressed in kilobits |
| Compressed_Flag | |
| Data_Type | |
| Filepath | // to be prepended by |
| $CACHEDIR | |

An example LTL record for a firewall is given below:

bcarh001.ca.nortel.com**fw-1-a-cc**FW**EAGLE**19990910**00**24**895**y**ASCII**transfe r/bcarh001/19990910-00/$LOGFILE

Log Exception List

A Log Exception List (LEL) is used to keep state of which SD have submitted logfiles for archival during the logfile retrieval interval. Each entry in the LEL is a record consisting of the following fields in order, and delimited in this example by two asterisks:

Date

Interval_Stamp

SD_Name

An example LEL record for a SD is given below:

19990910**00**bcarh001.ca.nortel.com

Log Manager Interaction with a Security Device

The Log Manager (LM) is an independent process working in conjunction with third-party Security Devices (SD) for the purposes of archiving the SD logfiles in a managed, centralized location.

The Security Device (SD) software must be configured such that the following occurs on a daily basis:

The SD logfile(s) must be transferred via an SD administrative process to the appropriate directory on the LM. An example UNIX directory representation is provided: LMName:$CACHEDIR/newlogs/$SDNAME /$DATE.$logfile

CACHEDIR is set in the LC.ini file

SDNAME is a sub-directory created in $CACHEDIR/newlogs by the SD administrative process, which identifies the specific SD that created the logfiles.

$DATE.$logfile := $DATE“.”$logfile

where:

$DATE := the date specified in YYYYMMDD ASCII format

$logfile := the name of the logfile generated by the SD

Preparing Security Device Logfiles for Archival

The LM cache directory (i.e. $CACHEDIR) contains three directories: “newlogs”; “transfer”; “archived”. Newly arrived logfiles from the SDs are found in the “newlogs” directory under the appropriate SDName directory. These logfiles must be prepared for transfer to the SM for archival. The “transfer” directory contains new SD logfiles which have been processed by the LM and are designated to be transferred to the Storage Manager (SM) for archival. The “archived” directory contains SD logfiles that have been transferred to the SM, and that are cached for the period of time specified by the $CleanupInterval.

At a regular interval determined by the value of $CheckInterval, the LM checks the $CACHEDIR/newlogs directory for any newly created directories. When a new directory is found, the logfiles contained in it are processed as follows:

Using the $DATE obtained from the logfile name (i.e. $DATE.$LOGFILE), and the corresponding $RetrievalInterval (e.g. 24 hrs.) for creating an IntervalStamp, the directory $CACHEDIR/transfer/$SDNAME/$DATE-$IntervalStamp is created.

An example subdirectory created in $CACHEDIR/transfer is provided below

$CACHEDIR = /sdlrs/logarchive

$SDNAME = bcarh001

$DATE = 19990910

$IntervalStamp = 00 // 24 divided by 24=1=“begin at midnight”=00

directory =/sdlrs/logarchive/transfer/bcarh001/199909 10-00

The logfiles contained in the $SDNAME directory are then compressed (if not already compressed) and moved from $CACHEDIR/newlogs/$SDNAME/$DATE.$LOGFILE to the correct “transfer” directory $CACHEDIR/transfer/$SDNAME/$DATE-$IntervalStamp/$LOGFILE

A record entry for each logfile to be transferred to the SM via the NetFile Put method is then created in the Log Transfer List (LTL). (The NetFile methods are detailed in the CORBA integration document [MA1].)

Transfer of Logfiles for Archival

Immediately after a period of preparing any newly arrived SD logfiles for transfer to the SM for archival, the LM then transfers the logfiles associated with the entries in the Log Transfer List (LTL) to the SM using the NetFile Put method detailed in the SDLRS CORBA integration document [MA1]. Upon successful completion of the logfile transfer, the following events occur:

A DAM-LogArchDone notification is sent to the DAM indicating that the SD logfiles are ready for analysis.

move the logfile from the “transfer” sub-directory $CACHEDIR/transfer/$SDNAME/$DATE-$IntervalStamp/$LOGFILE to the “archived” sub-directory $CACHEDIR/archived/$SDNAME/$DATE-$IntervalStamp/$LOGFILE

remove the corresponding record from the LTL

remove the corresponding record from the LEL

Clean Up of Logfiles After Archival

The LM keeps the SD logfiles that have been transferred to the SM for the duration specified in $CleanupInterval. On a daily basis, the LM removes any logfiles in the “archived” directory by doing the following:

using the file creation date stamp of the directory $CACHEDIR/archived/$SDNAME/$DATE-$IntervalStamp as the logfile origin date, remove any directory (i.e. $CACHEDIR/archived/$SDNAME/$DATE-$IntervalStamp) and its contents that have exceeded the $CleanupInterval in duration. This allows older logfiles which have been newly submitted to the LM to be archived for the desired duration.

Generating Logfile Archival Exceptions

The LM keeps state of the SD which have submitted logfiles to it during a $Retrievalnterval period. At the beginning of each retrieval interval period, the LM performs the following tasks in order:

Each record in the LEL represents a SD which did not submit its logfile(s) for an earlier interval period. The DAM is sent a notification for each LEL record indicating that it has not received the logfile(s) for the SD during the interval specified in the LEL record. This notification is done via DAM-Event as documented in the CORBA integration document [MA1].

The LM appends to the LEL an LEL record for each SD listed in the Security Device File (SDF).

Concurrent Event Handling

There are no special requirements for concurrency on the LM.

Activity Status File

The Activity Status File (ASF) contains state information for various activities going on in the LM. For example, as each logfile transfer operation to the SM is initiated, the LM stores the event related information so that if the system crashes, it can restart any pending activity.

The pending activity file syntax is:

StatFile := LMDIR“/” “LM.stt”

The syntax for each record is:

| ASFEntry | := | JobNumber Activity |
|---|---|---|
| JobNumber | := | Integer [4] |
| Activity | := | Log Prep \| Log Transfer \| |
| Archival Notification | | \| Cleanup |
| Log Prep | := | Status “;” DateTime “;” |
| SDName | | |
| Log Transfer | := | Status “;” DateTime “;” |

| | |
|---|---|
| LCMName “;” SDName “;” | \ |

LogAttributes“;” ErrorStatus

| | | |
|---|---|---|
| Archival Notification | := | Status “;” DateTime |

| “;” SDName “;” LCName “;” | | | \ |
|---|---|---|---|
| | | LogRefs | |
| Cleanup | := | Status “;” DateTime | |
| Status | := | “n” | // new but not acted |
| on | | | |

| | \| “s” | | // started job |
|---|---|---|---|
| | \| “c” | | // complete, just |
| cleaning up | | | |
| | \| “f” | | // failed, just |
| cleaning up | | | |
| | \| “r” | | // system |
| failure, job restarted | | | |
| DateTime | := | hh:mm:ss | // UNIX date/time |

(i.e. time())

Log Manager Event Logging

The LM logging uses syslog. Syslog should be setup with the following parameters:

void openlog(const char *ident = “LM”, int logopt
= LOG_PID+LOG_NOWAIT,

int facility = LOG_USER);

A message will be issued when the following occurs:

1) LM starts up, including command line parameters

2) LM shuts down

3) LM transfers log to SM using NetFile:Put method, including parameters

4) LM calls DAM-LogArchDone (log archival notification), including parameters

5) Significant state changes during log transfers (e.g. start, end, misc.)

6) Significant state changes during the creation of the Log Transfer List

7) LM calls DAM-Event during archival exception notifications

8) Security related events

9) When an error occurs

As much as possible the message part of the syslog( ) call should be in a machine parsable form.

Log Collector Manager

This section contains more detailed design information for the Log Collector Manager (LCM), which is a component of the Security Devices Log Reporting System (SDLRS) of the second embodiment. The LCM is responsible for the co-ordination and retrieval of a number of Security Device (SD) operational logs, and the transfering of those logs to the Storage Manager (SM) for archival. In fulfilling this role, the LCM also has corresponding interactions with the Data Analysis Manager (DAM) and Log Collector (LC) components of the SDLRS.

Design Representation

The intent of this section is to provide the architecture and design of the LCM and not the implementation specifics of the LCM. For ease of understanding the LCM system configuration, files and tables detailed in the design, example content and records are provided to highlight key fields and information that are required by the LCM. The actual implementation of the files and table content may vary.

Major Functions

Obtains the logging system configuration from the Data Analysis Manager (DAM) and propagates the configuration to the Log Collectors (LC) corresponding to the Security Devices (SD).

Notifies the LC to begin transferring the SD logfiles. Pushes the cached SD logfiles to the Storage Manager (SM) for archival.

Log archival status updates provided to the DAM.

CORBA Integration

The Log Collector Manager (LCM) acts as both a CORBA client and a CORBA server. The service requests that are defined in the CORBA integration document are referred to in this document whenever possible. They will appear as SR-n (where n is an integer) and preceded by the entity LCM. For example, the service request represented by the LCM receiving logging system configurations from the DAM is LCM SR-4.

System Variables

For UNIX-based LCM implementations the system variables are analogous to the UNIX shell environment variables (e.g. setenv in the csh) and can therefore be used for that purpose (e.g. setenv LCMDIR <DirLoc>, for the csh)

CACHEDIR := DirLoc

The CACHEDIR variable defines the location of the logfile cache directory, which contains the logfiles of security devices in transit to the Storage Manager (SM). This variable symbol is also used as a production in syntax definitions in this document.

LCMDIR := DirLoc

The LCMDIR variable defines the location of the LCM run-time directory, which contains the: configuration files; Log Collector Table; Security Device Table. This variable symbol is also used as a production in syntax definitions in this document.

Configuration Repository

The LCM configuration repository at version 1.0 will be a configuration file. It is located on the LCM host and uses the following syntax:

LCMConfigRep := LCMDIR “/” “LCM.ini”

In future versions of SDLRS, the LCM configuration repository may also be available via a database table.

If the LCM configuration repository is a database table, then it will use the following syntax:

LCMConfigRep := “LCMConfig”

Initialization

The LCM queries the Data Analysis Manager (DAM) for its Security Device (SD) list, and the log retrieval and cleanup interval configurations for the different device types.

The LCM validates that the Log Collector Table (LCT) exists, and is populated with the LC list received from the DAM.

The LCM validates that the Security Device Table (SDT) exists, and is populated with the corresponding SD to LC data.

The LCM notifies the Log Collectors (LC) of the log retrieval and cleanup interval configurations.

The LCM checks the pending activity file to see if it has any pending actions to execute or restart.

Log Collection Management

The LCM is responsible for retrieving Security Device (SD) logfiles from their associated Log Collectors (LC) and then sending them to the Storage Manager (SM) for archival. To perform this role within SDLRS, the LCM must manage the following aspects of the archival process:

manage a dynamic list of SD that could potentially change on a daily basis.

provide the LC, for which the LCM is responsible, with the retrieval and cleanup intervals.

notify the LC, for which the LCM is responsible, to begin logfile transfers for the SD associated with the LC.

act as a temporary cache for logfiles in-transit for archival on the SM.

notify the Data Analysis Manager (DAM) of SD logfiles that have been archived.

notify the DAM that all SD logfiles associated with the LC list have been archived.

Log Collector and Security Device Associations

A Log Collector (LC) manages the log archival for one or more Security Devices (SD) depending on the SD architecture. For example, there is a one-to-one relationship between LC and SD for Raptor firewalls, but there can be a one-to-many relationship between LC and Contivity Extranet Switches (CES), since a LC cannot be co-located with a CES at the time of writing this document. Therefore given this relationship of possible one-to-many SD to a LC, the LCM must manage which LC is responsible for which SD.

Log Collector List

The Log Collector (LC) List is the association of SD to LC generated by the Data Analysis Manager (DAM). From this LC List, the LCM manages the transition of SD logfiles to the Storage Manager (SM) for archival.

Acquiring the Log Collector List

On a daily basis, the LCM contacts the DAM for the list of LC for which the LCM is responsible for the day's log collection. Since the list of LC for which a LCM is responsible is of a potential dynamic nature, the LCM manages each day's LC list in a separate Log Collector Table and Security Device Table.

Log Collector Management Tables

The LCM manages the LC to SD relationship using two tables: Log Collector Table (LCT); Security Device Table (SDT). These tables are created using the data contained within the LC List. At the time that the LC List is retrieved from the DAM, the following events occur:

the LCM checks for a valid LCT and SDT, and if they exist writes the contents of the LCT and SDT to syslog as an error. The tables are then renamed with “WARNING” prepended to the table name.

the LCM creates a new LCT.

the SDT is created as the LCM sends “logfile transfer begin” notifications to the LC, and receives back the expected number of intervals of SD logfiles that will be archived.

Log Collector Table

A Log Collector Table (LCT) is used to maintain the status of: LC system configuration notifications; LC logfile transfer notifications; SD archival complete; LC archival complete.

Log Collector Table Naming Convention

The LCT name syntax is as follows:

| | | |
|---|---|---|
| LCTab.Date | := | “LCTab.”Date |

| | | |
|---|---|---|
| Date | := | MMDDYYYY |
| MM | := | (01\|02\|03\|04\|05\|06\|07\|08\|09\|10\|11\|12) |
| DD | := | (01\|02\|03\|04\|05\|06\|07\|08\|09\|10\|11\| |
| | | [. . .]\|20\|21\|[. . .]\|30\|31) |
| YYYY | := | Year expressed in string format |

Log Collector Table Format

The first 7 keys in the LCT define the characteristics of the table. These table characteristics are as follows:

| | |
|---|---|
| LCT Date | // Date of the LCT creation |
| LC Count | // Number of LC to manage |
| SD Count | // Number of SD with logfiles to |
| | archive |
| LC Config Notification Count | // Number of LC provided |
| | with system configuration |
| SD Logfile Transfer Count | // Number of SD begin- |
| | transfer-notifications |
| SD Archival Complete Count | // Number of SD with |
| | logfiles successfully archived |
| LC Archival Complete Count | // Number of LC complete |

Each subsequent entry in the LCT is a record consisting of the following fields in order, and delimited by two asterisks (i.e. ‘**’)

LC_Complete_Flag
Config_Sent_Flag
LC_Name
LC_IP_Address

| | |
|---|---|
| “SD1”(“,”“SD2”) [...] | // list of SD managed |
| by the LC | |

| | |
|---|---|
| “Log_Transfer_Begin1”(“,”“Log_Transfer_Begin2”) [...] | // |
| flags for SD list | |

| | |
|---|---|
| “Archival_Complete1”(“,”“Archival_Complete2”) [...] | // |
| flags for SD list | |
| where: | |
| SD“n”:={SD_Name, SD_IP_Address} | |

An example LCT record is given below:

n**y**fw-1-a-cc**47.150.48.2**bcarh001,47.150.48.2**y**n

The example LCT record indicates:

LC is still active

System configuration has been sent to the LC

LC name

LC IP address

SD Name, SD IP address

Request to begin log transfer for SD Name has been sent to the LC

Archival notification to the DAM has not been sent

Security Device Table

A Security Device Table (SDT) is used to maintain the status of: logfile transfer start time; logfile transfer current time; number of logfile transfer sessions expected; number of logfile transfer sessions completed; SD logfile attributes

Security Device Table Naming Convention

The SDT name syntax is as follows:

| | | |
|---|---|---|
| SDTab.Date | := | “SDTab.”Date |

| | | |
|---|---|---|
| Date | := | MMDDYYYY |
| MM | := | (01\|02\|03\|04\|05\|06\|07\|08\|09\|10\|11\|12) |
| DD | := | (01\|02\|03\|04\|05\|06\|07\|08\|09\|10\|11\| |
| | | [...]\|20\|21\|[...]\|30\|31) |
| YYYY | := | Year expressed in string format |

Security Device Table Format

The first 5 keys in the SDT define the characteristics of the table. These table characteristics are as follows:

| | |
|---|---|
| SDT Date | // Date of the SDT creation |
| Logfile Transfer Start Time | // Timestamp-first |
| | logfile transfer completed |
| Logfile Transfer Current Time | // Timestamp-last logfile |
| | transfer completed |
| Logfile Transfer Session Count | // Number of logfile |
| | transfer sessions expected |
| Logfile Transfer Complete Count | // Number of logfile |
| | transfer sessions completed |

Each subsequent entry in the SDT is a record consisting of the following fields in order, and delimited by two asterisks (i.e. ‘**’):

LC_Name
LC_IP_Address
SD_Name
SD_IP_Address
SD_Type
Logfile_Date
Retrieval_Interval
“Logfile_Type 1”(“,”“Logfile_Type 2”) [...]
“Logfile_Time 1”(“,”“Logfile_Time 2”) [...]
LogCacheDir

The LogCacheDir is unique for each entry in the table, and is the cache location within the $CACHEDIR for a security device's logfiles on that day. The format of the LogCacheDir is provided below:

LogCacheDir := Logfile_Date/SD_Name/

The logfiles within LogCacheDir reflect the Logfile_Type and Logfile_Time in the following format:

Logfile_Type1“-” Logfile_Time1“-” log

An example SDT record for a firewall is given below:

fw-1-a-cc**47.150.48.2**bcarh001**47.150.48.2**fw** 19990804**24**raptor4**00**19990804/bcarh001

An example of the logfile within the LogCacheDir is given below:

19990804/bcarh001/raptor4-00-log

Log Collector System Configurations

The LCM is responsible for retrieving from the DAM the system configurations relevant to Log Collectors (LC) for the Security Devices (SD), and pushing these system configurations to the LC assigned to the LCM for that particular day.

Obtaining Configurations from the Data Analysis Manager

On a daily basis the LCM sends a notification to the DAM to acquire the SDLRS configuration settings for retrieval and cleanup intervals, which the LCM then stores in a file in the LCM run-time directory.

Pushing Configurations to the Log Collectors

The LCM pushes the retrieval and cleanup interval configurations to each Log Collector (LC) with an entry in that day's Log Collector Table (LCT). The configuration notification is detailed in the LC SR-2 (Set Configuration Information) in the SDLRS CORBA integration document [MA1].

Transfer of Logfiles for Archival

Transferring Logfiles from the Log Collectors

The LCM notifies the LC to begin transferring logs to the LCM. The LC returns to the LCM the number of interval periods (e.g. default interval period equals 1 day) of SD logs that the LC intends to transfer to the LCM. The logfile date(s) associated with the interval period(s) is passed as part of the parameter list. The LCM upon receiving the intended number of logfile retrieval intervals for a SD creates a Security Device Table entry for each retrieval interval with the corresponding date associated with the retrieval interval.

After the return of the LC SR-3 notification, the LCM can expect the transferring of logfiles from the LC via LCM SR-2 (Transfer Log to LCM) for each corresponding interval period. An example is provided below:

interval period=24 hrs=1 day

number of interval periods of SD logs to transfer=3 days

number of logfiles per interval period for this SD=2 logfiles

LCM SR-2 called for: day1; day2; day3

number of logfiles transferred in each LCM SR-2 call=2 logfiles

When a LCM SR-2 (Transfer Log to LCM) is initiated, the corresponding SD logfiles are cached in the $CACHEDIR (See the “Security Device Table Format” section for cached logfile naming conventions.) At the successful completion of LCM SR-2, the LCM updates the appropriate SD record in the SDT for the corresponding interval period.

Transferring Logfiles to the Storage Manager

As the LCM receives logfiles from a LCM SR-2 call they are stored in the appropriate directory in $CACHEDIR. Once the transaction is complete and the SDT table updated, the logfiles are then transferred to the SM using SM SR-2 (Transfer Log to SM) detailed in the SDLRS CORBA integration document [MA1]. Upon successful completion of SM SR-2, the following events occur: Security Device Table (SDT) characteristics are updated, and the corresponding SD entry in the SDT removed.

A DAM SR-1 (Log Archival Complete) notification is sent to the DAM indicating that the SD logfiles are ready for analysis.

The Log Collector Table (LCT) characteristics are updated, and the corresponding LC entry in the LCT updated.

If LCM log archival is now complete for all SD, then a DAM SR-1 (Log Archival Complete) notification is sent to the DAM indicating that the LCM has completed all logfile archivals, and the day's LCT and SDT are removed after writing the table characteristics to the system log.

Logfile Archival Notifications to the Data Analysis Manager

The LCM sends logfile archival notifications to the DAM in the case where a SD logfiles have been successfully archived to the SM, and in the case where all the SD assigned to a LCM have successfully had their logfiles transferred to the SM for archival.

Notification of Security Device Log Archival Complete

Once the logfiles associated with an SD for a particular interval period have been transferred to the SM for archival, the LCM sends an archival complete notification to the DAM. The effect of the notification is for the DAM to begin the data analysis of the SD logfiles.

Notification of Log Archivals Complete

Once all of the SDs designated to the LCM by the DAM have had their logfiles archived on the SM, the LCM sends an archival complete notification to the DAM. The effect of the notification is to inform the DAM that the LCM has completed log archivals for that interval period.

Concurrent Event Handling

The nature of the LCM is that it will not have to deal with a large number of transactions-per-second (tps), but rather that the majority of LCM transactions will be of a long-lasting nature due to event-caused, prolonged, disk-related activity. Given these system specifics, the LCM must be able to handle multiple concurrent events. For example, a “transfer log to LCM” notification from a LC (LCM SR-2) can arrive from a LC at the same time as another LCM SR-2 is received from a different LC. Each of these events could potentially result in substantial disk activity given that logfiles can be of substantial size.

An efficient means of handling concurrency in this scenario is through lightweight threads. In the worst case of the LCM running on a single processor system, the overhead involved in thread creation and in context switching between threads is minimal when compared to the latency times associated with disk accesses. In the best case, of multiple disk controllers, and multiple processors on a SMP (symmetrical multi-processing) LCM system, threads would be able to concurrently process on different processors/disk controllers. For these reasons, the LCM should be implemented using threads rather than by an event loop.

Activity Status File

The Activity Status File (ASF) contains state information for various activities going on in the LCM. For example, as each logfile transfer notification from a LC is received, the LCM stores the event related information so that if the system crashes, it can restart any pending activity.

The information in the stat file can be displayed via LCM SR-1.

The pending activity file syntax is:

| | | |
|---|---|---|
| StatFile | := | LCMDIR“/” “LCM.stt” |

The syntax for each record is:

| | | |
|---|---|---|
| ASFEntry | := | JobNumber Activity |
| JobNumber | := | Integer [4] |
| Activity | := | Sys Config \| Cache \| SM Transfer \| |

Archival Notification

| | | |
|---|---|---|
| Sys Config | := | Status“;” DateTime “;” LCName |

“;” ConfigInfo

| | | |
|---|---|---|
| Cache | := | Status “;” DateTime “;” SDName “;” |

LCName “;” \
“;”LogRefs

| | | |
|---|---|---|
| SM Transfer | := | Status “;” DateTime “;” SDName |

“;” LCName “;” \
“;” LogRefs

| | | |
|---|---|---|
| Archival Notification | := | Status “;” DateTime “;” |

SDName “;” LCName “;” \
“;” LogRefID “;” ErrorStatus

| Status | := | “n” | // new but not acted on | |
|---|---|---|---|---|
| | | \| “s” | | // started job |
| | | \| “c” | | // complete, just cleaning |

up

| | |
|---|---|
| \| “f” | // failed, just cleaning up |
| \| “r” | // system failure, job |

restarted

| | | |
|---|---|---|
| DateTime | := | Base16 // UNIX date/time (i.e. |

time()) in base 16

Base16 Table

The table for the base16 representation is:

| | | | |
|---|---|---|---|
| Base16Table | := | “a” | // for 0 |
| | \| | “b” | // for 1 |
| | \| | “c” | // for 2 |
| | \| | “d” | // for 3 |
| | \| | “e” | // for 4 |
| | \| | “f” | // for 5 |
| | \| | “g” | // for 6 |
| | \| | “h” | // for 7 |
| | \| | “I” | // for 8 |
| | \| | “j” | // for 9 |
| | \| | “k” | // for 10 |
| | \| | “l” | // for 11 |
| | \| | “m” | // for 12 |
| | \| | “n” | // for 13 |
| | \| | “o” | // for 14 |
| | \| | “p” | // for 15 |

Log Collector Manager Event Logging

The LCM logging uses syslog. Syslog should be setup with the following parameters:

void openlog(const char *ident = “LCM”, int logopt =
LOG_PID+LOG_NOWAIT,
int facility = LOG_USER);

A message will be issued when the following occurs:

LCM starts up, including command line parameters

LCM shuts down

LCM receives LCM SR-1 (DAM requesting status info), including SR parameters

LCM receives LCM SR-2 (caching of log from LC), including SR parameters

LCM receives LCM SR-3 (LC requesting configuration info), including SR parameters

LCM receives LCM SR-4 (set configuraton information), including SR parameters

LCM calls DAM SR-1 (log archival notification), including SR parameters

LCM calls DAM SR-4 (obtain LC list), including SR parameters

LCM calls DAM SR-5 (obtain system configuration info), including SR parameters

LCM calls LC SR-1 (obtain LC status), including SR parameters

LCM calls LC SR-2 (set configuration info), including SR parameters

LCM calls LC SR-3 (transfer log info), including SR parameters

LCM calls SM SR-2 (log transter to SM), including SR parameters

Significant state changes during log transfers (e.g. start, end, misc.)

Significant state changes during Log

Significant state changes during the creation of Log

Collector Management Tables

Security related events

When an error occurs

As much as possible the message part of the syslog( ) call should be in a machine parsable form.

It is contemplated that the LCM may also specify date ranges of logfiles to be transferred from the Log Collectors.

Additional Description of Operation of the Log Collector Manager (LCM)

The number of LCMs in the system may be one or more with the responsibility of an LCM being that of co-ordination and retrieval of a number of different SD operational and system performance logs. The LCM contacts the Data Analysis Manager (DAM) on a 24 hour basis to acquire its assigned SD identification list, and the log retrieval and cleanup configuration settings for the system. During the log retrieval process, the LCM performs the following: initiates the connection to the LC; provides system configuration updates for log retrieval and log cleanup frequencies to the LC; securely pulls the SD log(s). Logs that have been securely pulled, are then securely pushed to the Storage Manager (SM) for archival with the LCM providing for each log transfer the device type, date, and SD name to the SM. Upon the transfer of an SD log(s) to the SM, the DAM is notified of the job status, and in the case of errors the error code. Upon completion of all log transfers, the LCM notifies the DAM with an “end of transactions” notification.

The following lists references to the LCM in other processes taken from the SDLRS design description above. A LC may be identified for each SD, or a group of SDs depending on the SD technology. In either case, the LC is responsible for the following during the log retrieval process: accessing the SD log(s), securely (i.e., authentication, privacy) transferring the SD log(s) to the Log Collection Manager (LCM); cleanup of transferred log(s) on the SD.

As part of the log transfer process, the LCM begins a secure log transfer to the SM with the date, device type, and SD name for the log being transferred.

SDs having been assigned hostnames/aliases that indicate their security function and geographical location are then categorized into SD lists associated with the LCM(s) in the system.

When an LCM contacts the DAM, the LCM is provided with the log retrieval, and log cleanup configurations, as well as the SD list for which that LCM is responsible. As the LCM(s) notify the DAM of the successful transfer of SD logs, the DAM then contacts the SM for the location of the SD log such that the appropriate data filter can be applied to the log.

Storage Manager

This section contains the detailed design information for the Storage Manager (SM), which is a component of the Security Devices Log Reporting System (SDLRS). The SM is responsible for the management of physical log archival storage/access, and the corresponding interaction with the Data Analysis Manager (DAM) and Log Collector Manager (LCM) components of the SDLRS.

Design Representation

The intent of this section is to provide the architecture and design of the SM and not the implementation specifics of the SM. For ease of understanding, the SM system configuration detailed in the design is provided to highlight key fields and information that are required by the SM. The actual implementation of the content may vary.

Major Functions of the Storage Manager

Receives Security Device (SD) logs from the Log Collector Manager (LCM) for system archival.

Management of online and offline log archivals, and the transition of logs from online to offline status.

Provides the Data Analysis Manager (DAM) with access to SD logs upon request.

Provides the DAM with access to the SM log archival tables upon request.

CORBA Integration

The Storage Manager (SM) acts as both a CORBA client and a CORBA server. The CORBA interface for the SM is defined in the SDLRS CORBA integration document. The service requests that are defined in the CORBA integration document are referred to in this document whenever possible. They will appear as the actual interface method name preceeded by “SM-”. For example, the service request represented by the SM providing logfile information to the DAM is SM-GetLogInfo.

Service Request Function Prototype

The service request functions are based on the service requests defined in the SM entity interface in the SDLRS CORBA integration document [MA1].

System Variables

For UNIX-based SM implementations, the system variables are analogous to the UNIX shell environment variables (e.g. setenv in the csh) and can therefore be used for that purpose (e.g. setenv SMDIR <DirLoc>, for the csh).

ARCHIVEDIR := Dirloc

The ARCHIVEDIR variable defines the location of the directory used to archive online logs according to their security device type.

RESTOREDIR := DirLoc

The RESTOREDIR variable defines the location of the SM restored logfile directory. This is the location where offline logs are to be restored to disk.

SMDIR := DirLoc

The SMDIR variable defines the location of the SM run-time directory, which contains the: configuration files; online and offline archival tables; log reference tables; restored log archival table; potentially other configuration files. This variable symbol is also used as a production in syntax definitions in this document.

SMDIRBKP := DirLoc

The SMDIRBKP variable defines the location of the SM configuration backup directory located on a different disk partition than that of the SMDIR directory. The primary reason for SMDIRBKP is to maintain a second copy of the log archival tables which are of a highly dynamic nature.

Configuration Repository

The SM configuration repository at version 1.0 will be a configuration file. It is located on the SM host and uses the following syntax:

SMConfigRep := SMDIR “/” “SM.ini”

In future versions of SDLRS, the SM configuration repository may also be available via a database table. If the SM configuration repository is a database table, then it will use the following syntax:

SMConfigRep := “SMConfig”

Initialization

The SM queries the DAM for the log archival interval configurations for the different device types.

The SM validates that the appropriate online and offline archival tables exist based on actual device_types (i.e. EntityTypes) for currently archived logfiles.

The SM checks the pending activity file to see if it has any pending actions to execute or restart.

The SM performs any necessary log cycling from on-line status to off-line status, and from off-line status to N/A status.

Log Archival Tables

A logfile has an archival status of either “online” or “offline”. This archival status must be maintained along with other logfile attributes for as long as the logfile exists within the system. To do this, an archival table is maintained for each type of security device's logs that are managed by the SM. The two exceptions to this are: 1) export controlled devices; 2) logfiles that have been previously offlined, and then restored. In each of these cases, separate tables are maintained, however, the table and record format in each case is identical. Maintaining a separate archival table for each security device type, allows for greater scalability of the system, which in turn will enhance the performance of table and logfile retrievals on a large system with many different types of security devices.

Archival Table Naming Convention

The security devices archive table name syntax is as follows for non-export-controlled security devices:

EntityTypeArchTbl := EntityType Hyphen “ArchTbl”

EntityType := as defined under “Modules”—CORBA integration [MA1]

The archive table name syntax for export-controlled security devices is as follows:

ExpEntityTypeArchTbl := “Exp” hyphen EntityType hypen “ArchTbl”

EntityType := as defined under “Modules”—CORBA integration [MA1]

The archival table name syntax for restored “offline” security device logfiles is as follows:

ResEntityTypeArchTbl := “Res” hyphen EntityType hyphen “ArchTbl”

EntityType := as defined under “Modules”—CORBA integration [MA1]

Creation of New Archival Tables

The security devices for which archival tables exist are defined within the system by the ‘EntityType’, as defined under the “Modules” section in the CORBA integration document [MA1]. The SM will create a new security device archival table if one does not already exist under the following conditions:

Upon receiving a logfile from an LCM, the security device type is extracted from the security device hostname alias, and validated against known “Entity Types”. If this is the first instance of a valid security device type log archival, then an archive table is created for the security device type.

An event which leads to the creation of a security device archival table will result in an alarm being generated and sent to the DAM via DAM-Event.

Archival Table Format

Determining Security Device Type

The security device type associated with a table is determined by parsing the archive table name. For example, the firewall archive table name would be “FW-ArchTbl”. The export controlled firewall archive table name would be “Exp-FW-ArchTbl”.

Archive Table Characteristics

An archive table is a chronologically ordered table based on the date and time of the actual log archival occurring on the SM. For this reason, no inserts to the table are required, as all new records will be appended to the table.

The table is of fixed record size.

The table contains records for logfiles with online status as well as offline status

The first two records of an archive table are reserved for table specifics. These specifics should include as a minimum:

Table offset for the first “Offline” archival record, and the “logfile date” associated with the archival record

Table offset for the first “Online” archival record, and the “logfile date” associated with the archival record

The records between the first archival record with an “Offline” status and the first archival record with an “Online” status, are logfiles deemed Offline.

The records following the first archival record with an “Online” status are logfiles deemed “Online”.

One archive record exists per archival directory regardless of the number of logfiles contained in that archival directory. The number of logfiles expected within an archival directory to be determined by the logfile retrieval-per-day interval.

Archive Record Format

A log archival record consists of the following required fields:

| | |
|---|---|
| Directory_Reference_ID | // unique path of the directory |
| | containing a logfile(s) |
| Logfile_Date | // date of logfile created by |
| | security device |
| Online_Status | // either Online, Offline, or |
| | Restored |
| Logfile_Type | // correlates to the type used by the |
| | data filter |
| Retrievals_Per_Day | // correlates to the # of |
| | logfiles per unique directory |
| SD_Name | // security device alias name |

Data is required for transaction audit purposes. This data would be relatively static for a device and hence may be better accessed through the SDLRS logging. However, they are included here as optional fields within an archival record:

| | |
|---|---|
| SD_IP_Address | // security device's IP address |
| LC_Name | // the name of the Log Collector |
| LCM_Name | // the name of the Log Collector |
| | Manager |

Archive Record Example

The following is an example of a log archival record for a non-export-controlled firewall including the required and optional fields in the record:

| | | |
|---|---|---|
| Directory_Reference_ID | := | “unique hash of DirPath” |

where
Dirpath =
$ARCHIVEDIR/Main/Wk_Of_The_Month/Device_Type/Logfile_Date
/SD_Name

| | | |
|---|---|---|
| Logfile_Date | = | 19991210 |
| Online_Status | = | “Enum type for Online” |
| Logfile_Type | = | EAGLE |
| Retrievals_Per_Day | = | 1 |
| SD_Name | = | fw-1-n-cn |
| SD_IP_Address | = | 47.1.2.3 |
| LC_Name | = | <hostname> |
| LCM_Name | = | <hostname> |

Logfile References

A “Logfile Reference” is used to uniquely identify a logfile archived on the SM. “Logfile References” are utilized by the SM for tracking logfiles requested by the DAM in either automated analysis mode or custom analysis mode.

Each “Logfile Reference” consists of a “Directory Reference ID” component and a “Logfile Name” component. Taken together these components comprise a Logfile Reference ID, which uniquely identifies a logfile archived on the SM.

Logfile Reference ID

Logfile Reference IDs are used by the SM in its communication (Open Method) between the SM and LCM objects, between the LCM and DAM objects (interface DAM-LogArchDone), and in its communication (Open Method and the interface SM-GetLogInfo) between the SM and DAM objects. The two parts which make up a “Logfile Reference ID” are the “Directory Reference ID” and the “Logfile Name”.

Directory Reference ID

The Directory Reference ID is a unique “hash number” based on the archival directory where a logfile will reside. Depending on the hashing algorithm used, the unique “hash number” may be of varying lengths. However, the ‘hash number’should not exceed 128 bits so that it does not negatively impact the size of archival table record entries where the Directory Reference ID is stored.

The archival directory to be hashed is of the following format:

E.g., Export-controlled Security Device directory $ARCHIVEDIR/ExpCtl/Wk_Of_The_Mon/Device_Type/Logfile_Date /SD_Name

E.g., Non-export-controlled Security Device directory $ARCHIVEDIR/Main/Wk_Of_The_Mon/Device_Type/Logfile_Date/S D_Name

Logfile Name

The “Logfile Name” component of a “Logfile Reference” is comprised of the “Logfile_Type” associated with a logfile, and a sequencing number. The boundaries of potential sequencing numbers determined by the “Retrievals_Per_Day”, and the existence of logfiles with sequencing numbers already contained within the archival directory.

The “Logfile Name” is of the following format:

Logfile_Type hyphen <sequence number>hyphen “log” period <compression tag>

E.g. Firewall logfile of type EAGLE and a retrieval interval of 2 provides up to two possible “Logfile Names”. With the GNU compression tag being used in this example, the two potential “Logfile Names” are:

EAGLE-1-log.gz

EAGLE-2-log.gz

Logfile Reference ID Format

A logfile is uniquely identified by combining the “Directory Reference ID” with a “Logfile Name”. An example is given below:

E.g. Logfile Reference ID for a unique firewall logfile of type EAGLE and a Retrieval Interval of 1 <16 bit hash of archival directory> .EAGLE-1-log

E.g. Logfile Reference ID for all logfiles of a firewall of logfile type EAGLE and a Retrieval Interval of 4 <16 bit hash of archival directory>

Directory Reference ID Index

A “Directory Reference ID” index is maintained for each archival table. As each “Directory Reference ID” identifies a unique archival record, the index is used to facilitate archival record lookups by associating the unique “Directory Reference ID” to the offset in the table where the archival record is stored.

Log Archival

Disk Archival

New logs for archival are received from a LCM via the Netfile methods (i.e. Open, Put, Close). The process of archiving a log is detailed below:

The SM checks for enough available disk space to receive the log in its entirety.

Based on the security device type, logfile date, and device alias, the appropriate archival directory is created if required and the logfile is received. (See the Logfile References section for the archival directory and logfile name formats.)

Upon receipt of the logfile(s) for the security device, a new entry is created in the applicable security device Archival Table if this is the first logfile to be stored in the archival directory.

Tape Archival

With online data archiving, the potential exists for large volumes of data to reside on the SM archival disks. This data can be broken down into dynamic data (e.g. newly archived logs) and static data (e.g. previously archived logs). To reduce the cost associated with tape archivals, it is therefore useful to architect the log archival directories/disks in such a manner that full backups of static data occur only once, which is at the time that the data volume becomes static. Incremental backups are then done on a nightly basis to backup any new logs archived that day.

Facilitating Low Cost Tape Archivals by Archival Directory

The SM will have incremental tape backups on a nightly basis and full backups of static archival directories/disks on a weekly basis. To facilitate this functionality, the online log archival filepaths will reflect the week of the month that the logfiles were generated. The weeks are defined as follows:

wk1 := days 1-7

wk2 := days 8-14

wk3 := days 15-21

wk4 := days 22-28+days 29, 30, 31 as required

Some example log archival filepaths are as follows:

1) Logfile_Date=19990804; Security Device Type=fw Logfile_Path=$ARCHIVEDIR/wk1/fw/19990804/fw-1-n-cn/EAGLE-1-log.gz

2) Logfile_Date=19990812; Security Device Type=fw Logfile_Path=$ARCHIVEDIR/wk2/fw/19990812/fw-1-n-cn/EAGLE-1-log.gz

3) Logfile_Date=19990829; Security Device Type=fw Logfile_Path=$ARCHIVEDIR/wk4/fw/19990829/fw-1-n-cn/EAGLE-1-log.gz

A weekly full backup tape archival can then be setup to archive $ARCHIVEDIR/wk[n] (where n=[1|2|3|4]) on a rotating basis. The rotation is based on the full backup to be done of the archival directory for the preceding week. The effect of this rotation is to reduce the incidence of reoccurring full backup tape archival of static data.

An example of a weekly full backup scenario is given below:

Sunday, August 31 full backup scheduled day of backup=31; days/wk=7 31 div 7=4

preceding week=(4−1)=3; (In the case where the preceding week is less than or equal to 0, the preceding week becomes equal to 4.)

full backup of $ARCHIVEDIR/wk3 to tape

Accessing Logs and Log Archival Tables

Logfiles once they are stored on the SM can be accessed via the DAM interface to the SM either as part of the automated analysis mode, or the logfiles can be accessed by the WAS via the DAM interface to the SM as part of the custom analysis mode. Logfile Archival Tables can also be accessed by the WAS via the DAM interface to the SM.

Accessing Logs

Automated Analysis Mode

In the automated analysis mode, a Directory Reference ID (DRID) and a log Archival Table entry are created at the time that the LCM successfully completes its transfer of a SD logfile(s) to the SM. The Logfile Reference ID (LRID) are passed back to the LCM, so that they may be passed to the DAM as part of the LCM log availability notification process (i.e. DAM-LogArchDone). The DAM then will provide the LRID as part of a log retrieval request to the SM.

Custom Analysis Mode

Obtaining Logfile Information

In the custom analysis mode, a request is received from the DAM (i.e. SM-GetLogInfo) in which logfile information is passed in the request. The SM then returns the requested logfile records from the associated security device Archival Tables.

Logfile Retrieval

An actual logfile retrieval request in custom analysis mode, will provide a Logfile Reference ID (LRID), which can uniquely identify a logfile for retrieval or a set of logfiles applicable to a security device for a particular date. The LRID for a unique logfile contains both a DRID and Logfile Name component. The LRID for the logfiles of a specific date may contain only a DRID component.

As it is possible in the custom analysis mode to have several concurrent requests for a particular logfile at one time, the SM must manage each log transaction independently from another.

Log Archival Tables

The retrieval of archival tables is based on three factors: security device type; whether the devices are export-controlled or not; whether the archival tables are for restored logfiles or not. A request from the DAM to return archival table entries is made through the SM interface SM-GetLogInfo.

Transitioning the Archival Status of Logs

Logfiles are archived on the SM for a specified online archival duration (e.g. by default the duration is three months). After the online archival period, a logfile record is tracked for the duration of the offline archival period. The time of the offline archival period being dependent on whether or not the security device is an export-controlled device. After the offline archival time period has transpired, the record of a logfile is no longer tracked.

Transitioning Occurrence

The transistioning of archival status from offline to N/A is done on a nightly basis, as it is essentially an archival table manipulation operation only. The transistioning of archival status from online to offline is done on a weekly basis rather than a daily basis. The advantage of this weekly processing is the ability to have archival transition occur on a day where log data volume is expected to be lower (i.e. Sunday) than during the rest of the week. The disadvantage to weekly processing is that approximately 86% of the logs will be archived online for an average 3 days longer than the configured monthly archival rate, which will result in a slight increase in the disk space required for online archival. For example, using the default three month online archival rate (90 days), an extra three days would necessitate an approximate 4% increase in disk space requirements.

Offline to N/A Status

Once a day, the SM transitions logfile records from offline status to N/A status. The SM does this in the following manner:

The first record of an archive table contains the offset of the first offline archival record.

Beginning with the first offline archival record, the SM sequentially examines the “logfile date” of each archival record to see if it meets the offline archival duration criteria.

The offset of the first archival record which meets the offline archival duration criteria is saved along with the “logfile date” to the first record of the archival table.

Online to Offline Status

Once a week, the SM transistions any logfile archival records that exceed the online archival duration to offline status. In the process, the SM also compresses the archival table by removing archival records that have exceeded the offline archival duration period, as well as rebuilds the Directory Reference ID index. The SM does this in the following manner:

The first record of an archival table contains the offset of the first offline archival record. The second record of an archival table contains the offset of the first online archival record.

The Directory Reference ID index associated with the archival table is recreated at the time of creating the newly compressed archival table.

Beginning with the first offline record, the archival table is rewritten. Logfile archival records are written to a temporary table with an updated offline status up to the first online archival record. (The offset of the first online archival record is provided in the second record of the archive table.)

Each subsequent archival record is then examined as to whether the ‘logfile date’ has exceeded the online archival duration period. If it has, and the ‘logfile date’ directory for that security device type (i.e. EntityType) exists, the ‘logfile_date’ directory is removed. The archival record is then written to the temporary table with an offline status.

The offset of the first archival record whose “logfile date” meets the online archival duration criteria is saved to the second record of the archival table, and the record written to the temporary table with an online status.

All subsequent records are written to the temporary table as is with no archival duration comparisons required.

The temporary table replaces the current table.

Restored Offline Logs

Restoring a Log

Restored logfiles from backups are differentiated from logfiles that are still online in order to make it easier to track them from an administrative perspective. Therefore, log restores will be restored to the RESTOREDIR/Newlogs directory.

Processing Log Restores

The SM on a hourly basis checks the RESTOREDIR/Newlogs directory for newly restored logfile directories. For each restored logfile directory, an archival record is created in the applicable “restored” archival table, (see Log Archival Tables section for more details) and the logfile directory is moved to the appropriate RESTOREDIR directory. An example is provided below:

Regular archival path:

$ARCHIVEDIR/Main/Wk_Of_The_Mon/Device_Type/Logfile_Date/S D_Name

Restored archival path:

$RESTOREDIR/Main/Wk_Of_The_Mon/Device_Type/Logfile_Date/S D_Name

A notification indicating that the logfile has been restored is then sent to the DAM via DAM-Event.

Transitioning Restored Logs

Restored logfiles are kept online for the restored logfile duration period, which has a default duration of one month. Restored logfiles are transistioned directly from online to N/A status on a weekly basis in the following manner:

As all archival records of a restored log archival table deal with online logs, the first two records used to store the first offline record offset, and the first online record offset are not required to be utilized. The same process of recreating the associated Directory Reference ID index and archive table as that for non-restored log archival tables is used but with the following difference. For each restored online archival record, the logfile's “last access” timestamp is used to determine if the restored logfile duration has been exceeded.

Concurrent Event Handling

The nature of the SM is that it will not have to deal with a large number of transactions-per-second (tps), but rather that the majority of SM transactions will be of a long-lasting nature due to event-caused, prolonged, disk-related activity. Given these system specifics, the SM must be able to handle multiple concurrent events. For example, a “transfer log to SM” notification from an LCM (SM SR-2), and a “transfer log from SM” notification from the DAM (SM SR-3) can arrive at the same time. Each of these events could potentially result in substantial disk activity given that logfiles can be of substantial size. The most efficient means of handling concurrency in this scenario is through lightweight threads. In the worst case of the SM running on a single processor system, the overhead involved in thread creation and in context switching between threads is minimal when compared to the latency times associated with disk accesses. In the best case, of multiple disk controllers, and multiple processors on a SMP (symmetrical multi-processing) SM system, threads would be able to concurrently process on different processors/disk controllers. For these reasons, the SM should be implemented using threads rather than by an event loop.

Activity Status File

The Activity Status File (ASF) contains state information for various activities going on in the SM. For example, as each logfile transfer notification from the LCM is received, the SM stores the event related information so that if the system crashes, it can restart any pending activity.

The information in the stat file can be displayed via SM-GetStatus.

The pending activity file syntax is:

| | |
|---|---|
| StatFile := | SMDIR”/” ”SM.stt” |

The syntax for each record is:

| | | |
|---|---|---|
| ASFEntry | := | JobNumber Activity |
| JobNumber | := | Integer [4] |
| Activity | := | Archival \| Access |
| Archival | := | Status “;” DateTime “;” SDName “;” |

LCMName “;” \
LogRefs

| | |
|---|---|
| Access := | Status “;” DateTime “;” SDType “;” SDName |
| “;” \ | |

SearchAttr “;” LogRefs “;”

| | | |
|---|---|---|
| Status | := | “n” // new but not acted on |

| | |
|---|---|
| \| “s” | // started job |
| \| “c” | // complete, just cleaning |

up

| | |
|---|---|
| \| “f” | // failed, just cleaning up |
| \| “r” | // system failure, job |

restarted
NOTE:
The “r” status applies to the automated analysis mode since the custom analysis mode is predicated on an initial web browser request to the DAM.

Storage Manager Event Logging

The SM logging uses syslog. Syslog should be setup with the following parameters:

void openlog(const char *ident = “SM”, int logopt =
LOG_PID+LOG_NOWAIT,
int facility = LOG_USER);

A message will be issued when the following occurs:

SM starts up, including command line parameters

SM shuts down

SM receives SM-GetLogInfo including all parameters

SM receives SM-GetStatus including all parameters

SM receives SM-SetConfigInfo including all parameters

SM receives SM-Noop

SM receives NetFile method calls (Open, Get, Put, Close) and associated parameters

Significant state changes during archival jobs (e.g. start, end, misc.)

Significant state changes during the creation/transitioning of archival tables

Security related events

When an error occurs

Initially the message part of the syslog( ) call should be in a machine parsable form. In the future, the message format should follow the Nortel Networks Common Logging Format.

Appendix A: SM Design Information From SDLRS Design Document

The following is the SM design information from the SDLRS specification design description above.

Storage Manager (SM)

The SM is responsible for SD log archival in the correct location, maintaining an index of log archivals according to SD and export control configuration settings, and backups of the log archiving system. As part of the log transfer process, the LCM begins a secure log transfer to the SM with the date, device type, and SD name for the log being transferred. From this information, the SM then selects the appropriate on-line archival directory where the log will be written. Upon successful completion of the log transfer, the SM then updates its index of log archivals.

To manage the transition of logs from on-line to off-line archival, the SM receives from the DAM the log retention configurations for the system on a daily basis. By default the log archival configurations are set at the following: perimeter devices—3 months on-line and 15 months off-line; export controlled devices—3 months on-line and 57 months off-line; drop-box devices—3 months on-line and 15 months off-line; devices classified as “other” (e.g. SPAM logs)—3 months on-line. The SM then manages the transition of on-line log archival to off-line archival by performing disk cycling, off-line archival backups, and the updating of the log archival index.

Upon receiving log location requests from the DAM, the SM references the archival index for the location of the log. If the log is on-line, then the file path is given to the DAM. If the log is found to be off-line, then the DAM is informed that the log is off-line. Archival information for specific SD logs or for the complete on-line or off-line indices can be provided to the DAM on request.

The DAM is responsible for providing the configuration details to the other system components, ensuring that all SD logs are archived, performing data analysis on SD logs, providing summary statistics to the Data Analysis Store (DAS), and querying the SM for log archival information upon request.

Logs that have been securely pulled, are then securely pushed to the Storage Manager (SM) for archival with the LCM providing for each log transfer the device type, date, and SD name to the SM.

As the LCM(s) notify the DAM of the successful transfer of SD logs, the DAM then contacts the SM for the location of the SD log such that the appropriate data filter can be applied to the log.

### Glossary

DAM: Data Analysis Manager—the system component which synchronizes the overall system, and performs the analysis on logs.

DAS: Data Analysis Store—the system database where the system configuration and summary metrics are stored.

IMMUNEsystem: Intrusion Monitoring and Management of Unified NEtworks system—an enterprise security environment of which the Security Devices Log and Reporting System is a part.

LC: Log Collector—the system component which directly interfaces with a Security Device logging mechanism.

LCM: Log Collection Manager—system component which manages the collection of all Security Device logs and transfers the logs to the Log Archival Unit.

LM: Log Manager—system component responsible for collecting security device logs and transferring the logs to the Log Archival Unit. A Log Collection Manager may comprise one or more Log Managers.

SD: Security Devices—devices used by the enterprise to manage data security within the enterprise network.

SDLRS: Security Devices Log and Reporting System

SM: Storage Manager—system component responsible for log archival, ad-hoc log retrieval, and backups.

WAS: Web Application Server—contains the applications which provide the system and data interfaces to the user.

WS: Web Server—the user's access point into the system

WC: Web Client—a web browser capable of interfacing with the web server for data presentation to the user.

| | |
|---|---|
| SECOPS: | Security Operations |
| SECINV: | Security Investigations |
| SPAN: | Electronic equivalent of “junk mail” |
| DRID | Directory Reference ID |
| LRID | Logfile Reference ID |
| LEL | Log Exception List |
| LTL | Log Transfer List |
| SDF | Security Device File |
| LCT | Log Collector Table |
| SDT | Security Device Table |
| RAS | Remote Access Services |

What is claimed is:

1. A security device log and reporting system for a data network, comprising:
a Log Collection unit, for collecting log files from security devices,
a Data Analysis and Log Archival unit for analysis and archival of log files,
and a Data and System Access Unit providing a user interface with the Data Analysis and Log Archival Unit.

2. A system according to claim 1 wherein the Log Collection unit comprises a Log Manager for managing log collection from a plurality of security devices.

3. A system according to claim 1 wherein the Log Collection Unit comprises a plurality of log collectors and a log collection manager for managing log collection from a plurality of log collectors.

4. A data network security management system for security device log archival and reporting comprising:
a log collection unit comprising a plurality of log collectors, each for collecting log files from a plurality of security device nodes and a log manager for collecting log files from the plurality of log collectors;
a data analysis and log archival unit for archival and automated analysis of log files transferred from the log manager,
and a data and system access unit providing a user interface to the Data Analysis and Log Archival Unit.

5. A system according to claim 4 wherein the log collection unit provides output to a storage manager and a Data Analysis manager, connected to a Data Analysis Store, of the Data Analysis and Log Archival unit, which also comprises a Archival unit associated with the Storage unit.

6. A system according to claim 4 wherein the user interface is a web based user interface

7. A system according to claim 1 wherein the data and system access unit wherein the user interface provides for log analysis summaries, trend analysis, controlled operational access and system configuration

8. A system according to claim 1 wherein the access unit comprises an authenticated, authorized, secured web based system.

9. A system according to claim 4 wherein the log collector receives logfiles from security devices comprising one or more device types comprising: Firewalls, CES, SPAM, FTP Drop Box and Anti-Virus.

10. A system according to claim 1 wherein the Log Manager LM interfaces with a Data Analysis Manager (DAM) and a Storage Manager (SM) and the LM comprises:
means for collecting logfiles from security devices,
means for pushing cached SD logfiles to a Storage manager for archival, and
means for providing log archival status updates to a Data Analysis Manager (DAM).

11. A Log Manager for a data network security management system, wherein the Log Manager LM interfaces with a Data Analysis Manager (DAM) and a Storage Manager (SM) and the LM comprises:
means for collecting logfiles from security devices, means for pushing cached SD logfiles to a Storage manager for archival, and means for providing log archival status updates to a Data Analysis Manager (DAM).

12. A system according to claim 1 wherein the Log Collector Manager (LCM) interfaces with a Data Analysis Manager (DAM) and a Storage Manager )SM) and the LCM comprises:
means for receiving logfiles from the plurality of log collectors,
means for obtaining a logging system configuration from the DAM,
means for propagating the configuration to individual LC associated with Security devices,
means for providing notification to the LC to begin transfer of SD log files, and
means for pushing cached SD log files to the Storage manager for archival, and
means for providing log archival status updates to the DAM.

13. A system according to claim 1 wherein the Data Analysis and Log Archival unit comprises a Storage Manager (SM) and a Data Analysis Manager (DAM) and the SM comprises
means to receive security device logs from the Log Collector Manager,
means for system archival,
means for management of online and offline log archivals and transition of logs form online to offline status,
means to provide the Data Analysis Manager (DAM) with access to SD logs on request, and
means to provide the DAM with access to the SM log Archival tables on request.

14. A security device log and reporting system wherein archival of log files is separated from analysis of logfiles.

15. A security device log and reporting system comprising a Log Manager, the Log Manager having a distributed interface for receiving logfiles from a plurality of security devices, and is the interface to a Data Analysis and Archival unit of the system.

16. A security device log and reporting system according to claim 15 wherein the Log manager comprises an intermediary caching system for log files received from the plurality of security devices.

17. A security device log and reporting system according to claim 14 comprising an Data Analysis and Archival Unit, a Log Collection Unit comprising a Log Manager, and Data and system Access Unit, wherein Data Analysis and Archival Unit interfaces with only a Log Manager and a Data and System Access Unit, whereby interfaces are easily protected via a firewall and instrusion detection system.

18. A method of managing security device log archival and reporting for a data network security, comprising
collecting log files from a security device node at a log collector
collecting log files from a plurality of log collectors at a log collection manager
transferring log files from the log collection manager to a data analysis and log archival unit for archival and analysis.

19. A method of managing security device log archival and reporting for a data network security, comprising
collecting log files from a security device node at a log collector
collecting log files from a plurality of log collectors at a log collection manager
transferring log files from the log collection manager to a data analysis and log archival unit for archival and analysis, logfile analysis being separated from log file archival.

20. A method according to 18 comprising providing user access to the Data analysis and log archival unit via a a data and system access unit.

21. A Storage Manager for a security device log archival and reporting system comprising means for receiving security device logs from the log collector manager for system archival,
means for management of online and offline log archival and transition of logs from online to offline status,
means for providing the DAM with access to security device logs on request,
means for providing the DAM with access to the SM log archival tables on request.

22. A storage manager according to claim 21 comprising means for differentiating types of log files.

23. A computer readable medium for implementing a method of managing security device log archival and reporting for a data network security, comprising
collecting log files from a security device node at a log collector
collecting log files from a plurality of log collectors at a log collection manager
transferring log files from the log collection manager to a data analysis and log archival unit for archival and analysis.

24. A method of managing security device log archival and reporting for a data network security, comprising
collecting log files from a security device node at a log collector
collecting log files from a plurality of log collectors at a log collection manager
transferring log files from the log collection manager to a data analysis and log archival unit for archival and analysis, logfile analysis being performed independently from log file archival.
